(19) United States
(12) Patent Application Publication
(10) Pub. No.: US 2023/0224921 A1
(43) Pub. Date: Jul. 13, 2023

(54) PHYSICAL DOWNLINK CONTROL CHANNEL TRANSMISSION METHOD AND APPARATUS

(71) Applicant: HUAWEI TECHNOLOGIES CO., LTD., Shenzhen (CN)

(72) Inventors: Lei CHEN, Chengdu (CN); Fengwei LIU, Chengdu (CN)

(21) Appl. No.: 18/185,737

(22) Filed: Mar. 17, 2023

Related U.S. Application Data
(63) Continuation of application No. PCT/CN2020/116264, filed on Sep. 18, 2020.

(51) Int. Cl. H04W 72/23; H04L 5/00; H04L 27/26; H04W 56/00

(52) U.S. Cl. CPC H04W 72/23; H04L 5/0053; H04L 27/2657; H04W 56/0015

(57) ABSTRACT

A physical downlink control channel transmission method and an apparatus. A terminal device obtains first indication information, where the first indication information indicates a time-frequency resource position of a first system information block 1 physical downlink control channel SIB1-PDCCH and an additional SIB1-PDCCH. The terminal device detects the first SIB1-PDCCH and the additional SIB1-PDCCH at the corresponding time-frequency resource position based on an indication of the first indication information, and obtains a system information block 1 SIB1 based on the detected first SIB1-PDCCH and the additional SIB1-PDCCH. In response to coverage of a SIB1-being is insufficient (for example, a higher frequency band), the first SIB1-PDCCH and the additional SIB1-PDCCH are jointly detected to improve a coverage capability of the SIB1-PDCCH, so that the terminal device obtains a SIB1 message and completes initial access.

### CROSS-REFERENCE TO RELATED APPLICATIONS

This application is a continuation of International Patent Application No. PCT/CN2020/116264, filed on Sep. 18, 2020, the disclosure of which is hereby incorporated by reference in its entirety.

### BACKGROUND

A large-scale antenna system technology may significantly improve a capacity and a coverage capability of a wireless communication system. In a new radio (new radio, NR) system, a base station may be equipped with dozens or even hundreds of antenna array elements, to benefit from higher system capacity and larger system coverage by using a massive MIMO (multiple-input multiple-output) technology. Large-scale antennas essentially mean that a large quantity of transmit antennas are used to send a signal based on channel characteristics of a transmitting end and a receiving end, so that the channel characteristics are better matched to obtain a gain. A common matching manner is, for example, beam transmission or frequency domain precoding. Therefore, a prerequisite for implementing a large-scale antenna gain is obtaining channel characteristic information.

For a data channel serving user equipment, the user equipment and the base station may perform a channel state information (channel state information, CSI) estimation procedure, so that channel characteristic information can be accurately obtained for massive MIMO transmission.

For a broadcast channel, because information transmitted by the base station serves all user equipment (including potential user equipment that is not accessed), the base station has almost no channel state information of a channel between the user equipment. As a result, broadcast information is transmitted only in a simple sending manner. For example, the broadcast information is divided into several beams and sent. Consequently, a coverage capability of the broadcast channel is weaker than that of the data channel.

A broadcast channel involved in an initial access process includes a synchronization signal block (synchronization signal block, SSB), a physical downlink control channel (physical downlink control channel, PDCCH), and a physical downlink data channel (physical downlink shared channel, PDSCH). To access a network, user equipment first needs to obtain a system information block (system information block, SIB) 1, where scheduling information of the SIB1 is carried on a system information block 1 physical downlink control channel SIB1-PDCCH.

With emergence of an application or a scenario of a new frequency band, for example, in a scenario of farther cell coverage or a case in which there is a larger path loss on the new frequency band, the user equipment cannot obtain a valid SIB1 message, and cannot complete initial access.

### SUMMARY

Embodiments described herein provide a physical downlink control channel transmission method and an apparatus.

According to a first aspect, at least one embodiment provides a physical downlink control channel transmission method. The method includes: obtaining first indication information, where the first indication information indicates a time-frequency resource position of a first system information block 1 physical downlink control channel SIB1-PDCCH and an additional SIB1-PDCCH; and

determining the time-frequency resource position of the first SIB1-PDCCH and the additional SIB1-PDCCH based on the first indication information.

In the foregoing embodiments, the first SIB1-PDCCH is understood as a SIB1-PDCCH in the existing 3GPP protocol 38.213, and the additional SIB1-PDCCH is understood as a supplementary SIB1-PDCCH that is added based on the first SIB1-PDCCH. A name of the supplementary SIB1-PDCCH is the additional SIB1-PDCCH, the supplementary SIB1-PDCCH, or another name. This is not limited in at least one embodiment. In response to coverage of a SIB1-PDCCH being insufficient (for example, a higher frequency band), the first SIB1-PDCCH and the additional SIB1-PDCCH are used to improve a coverage capability of the SIB1-PDCCH device.

With reference to the first aspect, in at least one embodiment, the method further includes: detecting the first SIB1-PDCCH and the additional SIB1-PDCCH based on the first indication information; and

obtaining a system information block 1 SIB1 based on the detected first SIB1-PDCCH and the additional SIB1-PDCCH.

Based on the foregoing solution, in response to a terminal device not detecting the first SIB1-PDCCH, the terminal device detects the additional SIB1-PDCCH based on an indication of the first indication information, to complete an initial access process. Alternatively, in response to the terminal device detecting the first SIB1-PDCCH but cannot correctly demodulate scheduling information carried by the first SIB1-PDCCH, the terminal device detects the additional SIB1-PDCCH, to jointly demodulate the detected additional SIB1-PDCCH and the first SIB1-PDCCH, so as to improve reliability of the SIB1-PDCCH, obtain the system information block SIB1, and complete an initial access process.

With reference to the first aspect, in at least one embodiment, the time-frequency resource position of the first SIB1-PDCCH and the additional SIB1-PDCCH includes a time-frequency resource position of the first SIB1-PDCCH and a time-frequency resource position of the additional SIB1-PDCCH; or an overall (or common) time-frequency resource position of the first SIB1-PDCCH and the additional SIB1-PDCCH.

Based on this solution, the first indication information indicates both the time-frequency resource position of the first SIB1-PDCCH and the time-frequency resource position of the additional SIB1-PDCCH, and no additional signaling overheads are introduced. Alternatively, the first indication information indicates the overall time-frequency resource position of the first SIB1-PDCCH and the additional SIB1-PDCCH, and similarly, no additional signaling overheads are introduced. In addition, in both manners, the additional SIB1-PDCCH is introduced to improve the coverage of the SIB1-PDCCH, and assist the terminal device in completing initial access.

With reference to the first aspect and at least one embodiment of the first aspect, the first indication information indicates one or more offsets, and the offset indicates an offset of the time-frequency resource position of the additional SIB1-PDCCH relative to the time-frequency resource position of the first SIB1-PDCCH; or the offset indicates an offset of the time-frequency resource position of the additional SIB1-PDCCH relative to a time-frequency resource position of a synchronization signal block SSB.

One or more time-frequency resource positions of the additional SIB1-PDCCH are obtained based on the one or more offsets.

Each of the one or more offsets includes at least one of a time domain offset and a frequency domain offset.

With reference to the first aspect and at least one embodiment of the first aspect, a quantity of symbols occupied by the first SIB1-PDCCH and the additional SIB1-PDCCH as a whole is greater than a quantity of symbols occupied by the first SIB1-PDCCH in time domain, and a quantity of resource blocks RBs occupied in frequency domain is greater than or equal to a quantity of RBs occupied by the first SIB1-PDCCH in frequency domain; or a quantity of RBs occupied in frequency domain at the overall time-frequency resource position occupied by the first SIB1-PDCCH and the additional SIB1-PDCCH as a whole is greater than a quantity of RBs occupied by the first SIB1-PDCCH in frequency domain, and a quantity of symbols occupied in time domain is greater than or equal to a quantity of symbols occupied by the first SIB1-PDCCH in time domain.

A time domain resource occupied by the first SIB1-PDCCH and the additional SIB1-PDCCH as a whole is at least one of symbols whose index numbers are 0 to 2.

Based on the foregoing solution, a problem that the time-frequency resource position of the additional SIB1-PDCCH conflicts with that of another resource (for example, a SIB1-PDSCH, a DMRS, or the first SIB1-PDCCH) is avoided, and an unnecessary detection behavior of the terminal device is reduced.

With reference to the first aspect and at least one embodiment of the first aspect, the time-frequency resource position of the additional SIB1-PDCCH does not overlap one or more of the time-frequency resource position of the first SIB1-PDCCH, the time-frequency resource position of the synchronization signal block SSB, a time-frequency resource position of a system information block 1 physical downlink data channel SIB1-PDSCH, and a time-frequency resource position of a system information block 1 physical downlink data channel demodulation reference signal SIB1-PDSCH DMRS.

With reference to the first aspect and at least one embodiment of the first aspect, in response to there being a plurality of offsets, the terminal device detects a plurality of time-frequency resource positions that are respectively indicated by the plurality of offsets and that are of the additional SIB1-PDCCH, and stops until the additional SIB1-PDCCH is detected.

Based on the foregoing solution, the plurality of offsets is predefined in a protocol, and the terminal device performs blind detection on the plurality of time-frequency resource positions that are respectively indicated by the plurality of offsets and that are of the additional SIB1-PDCCH. The terminal device assumes that only one of the plurality of time-frequency resource positions respectively corresponding to the plurality of offsets is transmitted. A flexible configuration of the plurality of offsets increases a probability that the terminal device detects the additional SIB1-PDCCH. For example, in response to a candidate time-frequency position being indicated by an offset and is of the additional SIB1-PDCCH not being detected, a candidate time-frequency position that is indicated by another offset and that is of the additional SIB1-PDCCH is detected. In addition, an indication of the plurality of offsets also improves flexibility of sending the additional SIB1-PDCCH by a network device.

With reference to the first aspect and at least one embodiment of the first aspect, the first indication information is carried on a broadcast channel PBCH.

With reference to the first aspect and at least one embodiment of the first aspect, the first indication information is carried in a specific SSB. To be specific, the terminal device receives a specific SSB signal, where the specific SSB signal carries the first indication information.

For example, the specific SSB signal carries the first indication information, and the first indication information indicates the time-frequency resource position of the first SIB1-PDCCH and the additional SIB1-PDCCH. An indication manner of the time domain resource position of the first SIB1-PDCCH and the additional SIB1-PDCCH is the same as an indication manner of the first SIB1-PDCCH in the protocol 38.213. For example, the first indication information is an index of a control resource set and search space, and the time-frequency resource position of the first SIB1-PDCCH and the additional SIB1-PDCCH is obtained based on specific configuration information indicated by the index.

With reference to the first aspect and at least one embodiment of the first aspect, the specific SSB signal includes at least one of the following information:

a primary synchronization signal of a specific sequence, a secondary synchronization signal of a specific sequence, a PBCH demodulation reference signal of a specific sequence, a special SSB structure, a special SSB time-frequency position, a synchronization signal SS of a specific frequency offset, or a PBCH of a specific frequency offset.

With reference to the first aspect and at least one embodiment of the first aspect, a candidate time-frequency resource position of the additional SIB1-PDCCH overlaps one of a candidate time-frequency resource position of the first SIB1-PDCCH, the time-frequency resource position of the synchronization signal block SSB, the time-frequency resource position of the system information block 1 physical downlink data channel SIB1-PDSCH, and the time-frequency resource position of a system information block 1 physical downlink data channel demodulation reference signal SIB1-PDSCH DMRS. The terminal device does not detect the additional SIB1-PDCCH at the time-frequency resource position of the additional SIB1-PDCCH.

Based on the foregoing solution, in response to the time-frequency resource position of the additional SIB1-PDCCH overlapping one of the foregoing resource positions, the terminal device assumes that the additional SIB1-PDCCH is not transmitted at the time-frequency resource position of the additional SIB1-PDCCH.

With reference to the first aspect and at least one embodiment of the first aspect, a frequency domain resource start position of the additional SIB1-PDCCH is the same as a frequency domain resource start position of an SSB corresponding to the first SIB1-PDCCH.

Based on the foregoing solution, the terminal device determines the time-frequency resource position of the additional SIB1-PDCCH based on a time-frequency resource position relationship between the additional SIB1-PDCCH and the SSB.

With reference to the first aspect and at least one embodiment of the first aspect, the additional SIB1-PDCCH is transmitted by default on a predetermined frequency band or frequency.

Based on the foregoing solution, in a scenario in which the coverage of the SIB1-PDCCH is severely insufficient (for example, a higher frequency band 6 GHz or farther cell coverage), the additional SIB1-PDCCH is transmitted by default, so that the coverage of the SIB1-PDCCH is effectively improved, and no additional signaling overheads are used.

With reference to the first aspect and at least one embodiment of the first aspect, the method further includes: obtaining second indication information, where the second indication information indicates whether the additional SIB1-PDCCH is transmitted.

Based on the foregoing solution, whether the additional SIB1-PDCCH is transmitted is dynamically indicated by the second indication information. This helps reduce power consumption of the terminal device and improve detection efficiency.

With reference to the first aspect and at least one embodiment of the first aspect, the second indication information is carried on the PBCH.

With reference to the first aspect and at least one embodiment of the first aspect, the first SIB1-PDCCH carries the second indication information, and the second indication information specifically indicates whether the additional SIB1-PDCCH corresponding to the first SIB1-PDCCH is transmitted; whether additional SIB1-PDCCHs corresponding to first SIB1-PDCCHs corresponding to all SSBs are transmitted; or to transmit the additional SIB1-PDCCH in a preset time unit.

With reference to the first aspect and at least one embodiment of the first aspect, in response to the specific SSB signal being received, the additional SIB1-PDCCH is determined to be transmitted.

In the first aspect and at least one embodiment of the first aspect, an attribute of the additional SIB1-PDCCH is the same as an attribute of the first SIB1-PDCCH.

In at least one embodiment, the additional SIB1-PDCCH is independently demodulated, and the additional SIB1-PDCCH and the first SIB1-PDCCH carry corresponding scheduling information. The corresponding scheduling information includes one or more of the following information: a frequency domain resource of a physical downlink shared channel PDSCH, a time domain resource of the PDSCH, a code rate and a modulation order of the same PDSCH, and a redundancy version of the PDSCH.

The terminal device assumes that a demodulation reference signal sequence of the additional SIB1-PDCCH is the same as a demodulation reference signal sequence of the first SIB1-PDCCH. The terminal device alternatively assumes that precoding used by the additional SIB1-PDCCH is the same as that used by the first SIB1-PDCCH.

Based on the foregoing solution, the additional SIB1-PDCCH and the first SIB1-PDCCH is combined for detection.

In addition, the additional SIB1-PDCCH is checked by using a radio network temporary identifier SI-RNTI of first system information. Alternatively, the additional SIB1-PDCCH is checked by using a second SI-RNTI, where the second SI-RNTI is generated based on a cell identifier.

In at least one embodiment, the additional SIB1-PDCCH is a supplementary resource of the first SIB1-PDCCH, and cannot be independently demodulated. The additional SIB1-PDCCH and the first SIB1-PDCCH jointly carry the scheduling information carried by the first SIB1-PDCCH. Rate matching is performed on the first SIB1-PDCCH and the additional SIB1-PDCCH as a whole.

Based on the foregoing solution, the additional SIB1-PDCCH is a supplementary resource of the first SIB1-PDCCH. In a scenario in which the first SIB1-PDCCH is not completely extended, a resource overhead configuration is more flexible, and robustness of the SIB1-PDCCH is improved.

Further, a detection periodicity of the additional SIB1-PDCCH is the same as a detection periodicity of the first SIB1-PDCCH. Alternatively, the PBCH or the first SIB1-PDCCH carries third indication information, where the third indication information indicates a detection periodicity of the additional SIB1-PDCCH. For example, the detection periodicity is 20 ms*k, where k is an integer greater than 1, for example, k=2, 4, 8, 16, 32, or 64; or k is a number greater than 0 and less than 1, for example, k=1/2, 1/4, 1/8, 1/10, 1/20, or 1/40.

Based on the foregoing solution, in response to the detection periodicity of the additional SIB1-PDCCH being less than or equal to the detection periodicity of the first SIB1-PDCCH, the additional SIB1-PDCCH is received in the detection periodicity of the first SIB1-PDCCH. In other words, the first SIB1-PDCCH and the additional SIB1-PDCCH is detected in one detection period, and the first SIB1-PDCCH and the additional SIB1-PDCCH are jointly demodulated, to improve the coverage of the SIB1-PDCCH. In addition, the detection periodicity of the additional SIB1-PDCCH is an integer multiple of the detection periodicity of the first SIB1-PDCCH, for example, is 40 ms or 60 ms. This improves the coverage of the SIB1-PDCCH to some extent, and reduces signaling overheads.

Further, the additional SIB1-PDCCH and the first SIB1-PDCCH are in a quasi co-located QCL relationship;

the additional SIB1-PDCCH and an SSB corresponding to the first SIB1-PDCCH are in a QCL relationship; or

the additional SIB1-PDCCH and the specific SSB signal are in a QCL relationship.

Based on the foregoing solution, for a system in which a network device performs transmission by using a beam or a terminal device selects a beam for receiving, based on the foregoing quasi co-located relationship, the terminal device receives the additional SIB1-PDCCH by using a receive beam for receiving the first SIB1-PDCCH; receive the additional SIB1-PDCCH by using a receive beam for receiving the SSB corresponding to the first SIB1-PDCCH; or receive the additional SIB1-PDCCH by using a receive beam for receiving the specific SSB.

According to a second aspect, at least one embodiment provides a physical downlink control channel transmission method. The method includes: A network device determines a time-frequency resource position of a first system information block 1 physical downlink control channel SIB1-PDCCH and an additional SIB1-PDCCH; and sends first indication information, where the first indication information indicates the time-frequency resource position of the first SIB1-PDCCH and the additional SIB1-PDCCH.

With reference to the second aspect, in at least one embodiment, the time-frequency resource position of the first SIB1-PDCCH and the additional SIB1-PDCCH includes: a time-frequency resource position of the first SIB1-PDCCH and a time-frequency resource position of the additional SIB1-PDCCH; or an overall time-frequency resource position of the first SIB1-PDCCH and the additional SIB1-PDCCH.

With reference to the second aspect and at least one embodiment of the second aspect, the first indication information includes one or more offsets, and the offset indicates an offset of the time-frequency resource position of the additional SIB1-PDCCH relative to the time-frequency resource position of the first SIB1-PDCCH; or

the offset indicates an offset of the time-frequency resource position of the additional SIB1-PDCCH relative to a time-frequency resource position of a synchronization signal block SSB.

With reference to the second aspect and at least one embodiment of the second aspect, a quantity of symbols occupied in time domain at the overall time-frequency resource position of the first SIB1-PDCCH and the additional SIB1-PDCCH is greater than a quantity of symbols occupied by the first SIB1-PDCCH in time domain, and a quantity of resource blocks RBs occupied in frequency domain is greater than or equal to a quantity of RBs occupied by the first SIB1-PDCCH in frequency domain; or a quantity of RBs occupied in frequency domain at the overall time-frequency resource position occupied by the first SIB1-PDCCH and the additional SIB1-PDCCH as a whole is greater than a quantity of RBs occupied by the first SIB1-PDCCH in frequency domain, and a quantity of symbols occupied in time domain is greater than or equal to a quantity of symbols occupied by the first SIB1-PDCCH in time domain.

With reference to the second aspect and at least one embodiment of the second aspect, a time domain resource occupied by the first SIB1-PDCCH and the additional SIB1-PDCCH as a whole is at least one of symbols whose index numbers are 0 to 2.

With reference to the second aspect and at least one embodiment of the second aspect, a physical broadcast channel PBCH carries the first indication information.

With reference to the second aspect and at least one embodiment of the second aspect, the network device sends a specific SSB signal, and the specific SSB signal carries the first indication information.

With reference to the second aspect and at least one embodiment of the second aspect, the specific SSB signal includes at least one of the following information:

a primary synchronization signal of a specific sequence, a secondary synchronization signal of a specific sequence, a PBCH demodulation reference signal of a specific sequence, a special SSB structure, a special SSB time-frequency position, a synchronization signal SS of a specific frequency offset, or a PBCH of a specific frequency offset.

With reference to the second aspect and at least one embodiment of the second aspect, a frequency domain resource start position of the additional SIB1-PDCCH is the same as a frequency domain resource start position of an SSB corresponding to the first SIB1-PDCCH, or a frequency domain resource start position of the additional SIB1-PDCCH is the same as a frequency domain resource start position corresponding to the specific SSB signal.

With reference to the second aspect and at least one embodiment of the second aspect, the additional SIB1-PDCCH is transmitted by default on a predetermined frequency band or frequency.

With reference to the second aspect and at least one embodiment of the second aspect, the network device sends second indication information, where the second indication information indicates whether the additional SIB1-PDCCH is transmitted.

With reference to the second aspect and at least one embodiment of the second aspect, a PBCH carries the second indication information.

With reference to the second aspect and at least one embodiment of the second aspect, the first SIB1-PDCCH carries the second indication information, and the second indication information specifically indicates whether the additional SIB1-PDCCH corresponding to the first SIB1-PDCCH is transmitted; whether additional SIB1-PDCCHs corresponding to first SIB1-PDCCHs corresponding to all SSBs are transmitted; or to transmit the additional SIB1-PDCCH in a preset time unit.

With reference to the second aspect and at least one embodiment of the second aspect, in response to the network device sending the specific SSB signal, the additional SIB1-PDCCH is determined to be transmitted.

In the second aspect and at least one embodiment of the second aspect, an attribute of the additional SIB1-PDCCH is the same as an attribute of the first SIB1-PDCCH.

In at least one embodiment, the additional SIB1-PDCCH is independently demodulated, and the additional SIB1-PDCCH and the first SIB1-PDCCH carry corresponding scheduling information. The corresponding scheduling information includes one or more of the following information: a frequency domain resource of a physical downlink shared channel PDSCH, a time domain resource of the PDSCH, a code rate and a modulation order of the PDSCH, and a redundancy version of the PDSCH.

A demodulation reference signal sequence of the additional SIB1-PDCCH is the same as a demodulation reference signal sequence of the first SIB1-PDCCH; or precoding used by the additional SIB1-PDCCH is the same as that used by the first SIB1-PDCCH.

In addition, the additional SIB1-PDCCH is checked by using a radio network temporary identifier SI-RNTI of first system information. Alternatively, the additional SIB1-PDCCH is checked by using a second SI-RNTI, where the second SI-RNTI is generated based on a cell identifier.

Optionally, the additional SIB1-PDCCH is a supplementary resource of the first SIB1-PDCCH, and cannot be independently demodulated. The additional SIB1-PDCCH and the first SIB1-PDCCH jointly carry the scheduling information carried by the first SIB1-PDCCH. Rate matching is performed on the first SIB1-PDCCH and the additional SIB1-PDCCH as a whole.

Based on the foregoing solution, the additional SIB1-PDCCH is a supplementary resource of the first SIB1-PDCCH. In a scenario in which the first SIB1-PDCCH is not completely extended, a resource overhead configuration is more flexible.

Further, a sending periodicity of the additional SIB1-PDCCH is the same as a sending periodicity of the first SIB1-PDCCH. Alternatively, the PBCH or the first SIB1-PDCCH carries third indication information, where the third indication information indicates a sending periodicity of the additional SIB1-PDCCH. For example, the sending periodicity is 20 ms*k, where k is an integer greater than 1, for example, k=2, 4, 8, 16, 32, or 64; or k is a number greater than 0 and less than 1, for example, k=1/2, 1/4, 1/8, 1/10, 1/20, or 1/40.

Further, the additional SIB1-PDCCH and the first SIB1-PDCCH are in a quasi co-located QCL relationship;

the additional SIB1-PDCCH and an SSB corresponding to the first SIB1-PDCCH are in a QCL relationship; or

the additional SIB1-PDCCH and the specific SSB signal are in a QCL relationship.

For beneficial effects of the implementations provided in the second aspect of embodiments described herein, refer to beneficial effects of the first aspect and at least one embodiment of the first aspect. Details are not described herein again.

According to a third aspect, at least one embodiment provides a terminal device, configured to perform the method in at least one embodiment of the first aspect. The terminal device is the terminal device in at least one embodiment of the first aspect, or a module used in the terminal device, for example, a chip or a chip system. The terminal device includes a module, unit, or means (means) corresponding to the method performed by the terminal device in at least one embodiment of the first aspect. The module, unit, or means is implemented by hardware or software, or is implemented by hardware executing corresponding software. The hardware or the software includes one or more modules or units corresponding to the function performed by the terminal device in at least one embodiment of the first aspect.

With reference to the third aspect, in at least one embodiment, the terminal device includes a transceiver unit and a processing unit. The transceiver unit is configured to obtain first indication information, where the first indication information indicates a time-frequency resource position of a first system information block 1 physical downlink control channel SIB1-PDCCH and an additional SIB1-PDCCH.

The processing unit is configured to determine the time-frequency resource position of the first SIB1-PDCCH and the additional SIB1-PDCCH based on the first indication information.

With reference to at least one embodiment of the third aspect, the processing unit is further configured to detect the first SIB1-PDCCH and the additional SIB1-PDCCH based on the first indication information; and the processing unit is further configured to obtain a system information block 1 SIB1 based on the detected first SIB1-PDCCH and the additional SIB1-PDCCH.

With reference to at least one embodiment of the third aspect, the time-frequency resource position of the first SIB1-PDCCH and the additional SIB1-PDCCH includes: a time-frequency resource position of the first SIB1-PDCCH and a time-frequency resource position of the additional SIB1-PDCCH; or an overall time-frequency resource position of the first SIB1-PDCCH and the additional SIB1-PDCCH.

With reference to at least one embodiment of the third aspect, the first indication information includes one or more offsets, and the offset indicates an offset of the time-frequency resource position of the additional SIB1-PDCCH relative to the time-frequency resource position of the first SIB1-PDCCH; or the offset indicates an offset of the time-frequency resource position of the additional SIB1-PDCCH relative to a time-frequency resource position of a synchronization signal block SSB.

The processing unit obtains one or more time-frequency resource positions of the additional SIB1-PDCCH based on the one or more offsets.

With reference to at least one embodiment of the third aspect, a quantity of symbols occupied in time domain at the overall time-frequency resource position of the first SIB1-PDCCH and the additional SIB1-PDCCH is greater than a quantity of symbols occupied by the first SIB1-PDCCH in time domain, and a quantity of resource blocks RBs occupied in frequency domain is greater than or equal to a quantity of RBs occupied by the first SIB1-PDCCH in frequency domain; or a quantity of RBs occupied in frequency domain at the overall time-frequency resource position of the first SIB1-PDCCH and the additional SIB1-PDCCH is greater than a quantity of RBs occupied by the first SIB1-PDCCH in frequency domain, and a quantity of symbols occupied in time domain is greater than or equal to a quantity of symbols occupied by the first SIB1-PDCCH in time domain.

With reference to at least one embodiment of the third aspect, a time domain resource of the first SIB1-PDCCH and the additional SIB1-PDCCH is at least one of symbols whose index numbers are 0 to 2.

With reference to at least one embodiment of the third aspect, the first indication information is carried on a physical broadcast channel PBCH.

With reference to at least one embodiment of the third aspect, the transceiver unit receives a specific SSB signal, and the specific SSB signal carries the first indication information.

With reference to at least one embodiment of the third aspect, the specific SSB signal includes at least one of the following information:

a primary synchronization signal of a specific sequence, a secondary synchronization signal of a specific sequence, a PBCH demodulation reference signal of a specific sequence, a special SSB structure, a special SSB time-frequency position, a synchronization signal SS of a specific frequency offset, or a PBCH of a specific frequency offset.

With reference to at least one embodiment of the third aspect, the additional SIB1-PDCCH is transmitted by default on a predetermined frequency band or frequency.

With reference to at least one embodiment of the third aspect, the transceiver unit obtains second indication information, and the second indication information indicates whether the additional SIB1-PDCCH is transmitted.

In the third aspect and at least one embodiment of the third aspect, an attribute of the additional SIB1-PDCCH is the same as an attribute of the first SIB1-PDCCH.

In at least one embodiment, the additional SIB1-PDCCH is independently demodulated, and the additional SIB1-PDCCH and the first SIB1-PDCCH carry corresponding scheduling information. The corresponding scheduling information includes one or more of the following information: a frequency domain resource of a physical downlink shared channel PDSCH, a time domain resource of the PDSCH, a code rate and a modulation order of the PDSCH, and a redundancy version of the PDSCH.

The terminal device assumes that a demodulation reference signal sequence of the additional SIB1-PDCCH is the same as a demodulation reference signal sequence of the first SIB1-PDCCH. The terminal device alternatively assumes that precoding used by the additional SIB1-PDCCH is the same as that used by the first SIB1-PDCCH.

In addition, the additional SIB1-PDCCH is checked by using a radio network temporary identifier SI-RNTI of first system information. Alternatively, the additional SIB1-PDCCH is checked by using a second SI-RNTI, where the second SI-RNTI is generated based on a cell identifier.

Optionally, the additional SIB1-PDCCH is a supplementary resource of the first SIB1-PDCCH, and cannot be independently demodulated. The additional SIB1-PDCCH and the first SIB1-PDCCH jointly carry the scheduling information carried by the first SIB1-PDCCH. Rate matching is performed on the first SIB1-PDCCH and the additional SIB1-PDCCH as a whole.

Further, a detection periodicity of the additional SIB1-PDCCH is the same as a detection periodicity of the first SIB1-PDCCH. Alternatively, the PBCH or the first SIB1-PDCCH carries third indication information, where the third indication information indicates a detection periodicity of the additional SIB1-PDCCH. For example, the detection periodicity is 20 ms*k, where k is an integer greater than 1, for example, k=2, 4, 8, 16, 32, or 64; or k is a number greater than 0 and less than 1, for example, k=1/2, 1/4, 1/8, 1/10, 1/20, or 1/40.

Further, the additional SIB1-PDCCH and the first SIB1-PDCCH are in a quasi co-located QCL relationship;

the additional SIB1-PDCCH and an SSB corresponding to the first SIB1-PDCCH are in a QCL relationship; or

the additional SIB1-PDCCH and the specific SSB signal are in a QCL relationship.

With reference to the third aspect, in at least one embodiment, the terminal device includes at least one processor and a transceiver, and optionally further includes a memory. The memory is coupled to the processor or is separated from the processor. The transceiver is configured to receive and send data, and is configured to communicate and interact with another device in a communication system. The memory is configured to store a computer program. The processor is configured to support the terminal device in performing a corresponding function of the terminal device in the first aspect and at least one embodiment of the first aspect.

For beneficial effects of the implementations of the terminal device provided in the third aspect of embodiments described herein, refer to beneficial effects of the first aspect and at least one embodiment of the first aspect. Details are not described herein again.

According to a fourth aspect, at least one embodiment provides a network device, configured to perform the method in at least one embodiment of the second aspect. The network device is the network device in at least one embodiment of the second aspect, or a module used in the network device, for example, a chip or a chip system. The network device includes a module, unit, or means (means) corresponding to the method performed by the network device in at least one embodiment of the second aspect. The module, unit, or means is implemented by hardware or software, or is implemented by hardware executing corresponding software. The hardware or the software includes one or more modules or units corresponding to the function performed by the network device in at least one embodiment of the second aspect.

With reference to the fourth aspect, in at least one embodiment, the network device includes a transceiver unit and a processing unit. The processing unit is configured to determine a time-frequency resource position of a first system information block 1 physical downlink control channel SIB1-PDCCH and an additional SIB1-PDCCH.

The transceiver unit is configured to send first indication information, where the first indication information indicates the time-frequency resource position of the first SIB1-PDCCH and the additional SIB1-PDCCH.

With reference to at least one embodiment of the fourth aspect, the time-frequency resource position of the first SIB1-PDCCH and the additional SIB1-PDCCH includes: a time-frequency resource position of the first SIB1-PDCCH and a time-frequency resource position of the additional SIB1-PDCCH; or an overall time-frequency resource position of the first SIB1-PDCCH and the additional SIB1-PDCCH.

With reference to at least one embodiment of the fourth aspect, the first indication information includes one or more offsets, and the offset indicates an offset of the time-frequency resource position of the additional SIB1-PDCCH relative to the time-frequency resource position of the first SIB1-PDCCH; or the offset indicates an offset of the time-frequency resource position of the additional SIB1-PDCCH relative to a time-frequency resource position of a synchronization signal block SSB.

With reference to at least one embodiment of the fourth aspect, a quantity of symbols occupied in time domain at the overall time-frequency resource position of the first SIB1-PDCCH and the additional SIB1-PDCCH is greater than a quantity of symbols occupied by the first SIB1-PDCCH in time domain, and a quantity of resource blocks RBs occupied in frequency domain is greater than or equal to a quantity of RBs occupied by the first SIB1-PDCCH in frequency domain; or a quantity of RBs occupied in frequency domain at the overall time-frequency resource position of the first SIB1-PDCCH and the additional SIB1-PDCCH is greater than a quantity of RBs occupied by the first SIB1-PDCCH in frequency domain, and a quantity of symbols occupied in time domain is greater than or equal to a quantity of symbols occupied by the first SIB1-PDCCH in time domain.

With reference to at least one embodiment of the fourth aspect, a time domain resource of the first SIB1-PDCCH and the additional SIB1-PDCCH is at least one of symbols whose index numbers are 0 to 2.

With reference to at least one embodiment of the fourth aspect, a physical broadcast channel PBCH carries the first indication information.

With reference to at least one embodiment of the fourth aspect, the transceiver unit sends a specific SSB signal, and the specific SSB signal carries the first indication information.

With reference to at least one embodiment of the fourth aspect, the specific SSB signal includes at least one of the following information:

a primary synchronization signal of a specific sequence, a secondary synchronization signal of a specific sequence, a PBCH demodulation reference signal of a specific sequence, a special SSB structure, a special SSB time-frequency position, a synchronization signal SS of a specific frequency offset, or a PBCH of a specific frequency offset.

With reference to at least one embodiment of the fourth aspect, the additional SIB1-PDCCH is transmitted by default on a predetermined frequency band or frequency.

With reference to at least one embodiment of the fourth aspect, the transceiver unit obtains second indication information, and the second indication information indicates whether the additional SIB1-PDCCH is transmitted.

In the fourth aspect and at least one embodiment of the fourth aspect, an attribute of the additional SIB1-PDCCH is the same as an attribute of the first SIB1-PDCCH.

In at least one embodiment, the additional SIB1-PDCCH is independently demodulated, and the additional SIB1-PDCCH and the first SIB1-PDCCH carry corresponding scheduling information. The corresponding scheduling information includes one or more of the following information: a frequency domain resource of a physical downlink shared channel PDSCH, a time domain resource of the PDSCH, a code rate and a modulation order of the PDSCH, and a redundancy version of the PDSCH.

A demodulation reference signal sequence of the additional SIB1-PDCCH is the same as a demodulation reference signal sequence of the first SIB1-PDCCH; or precoding used by the additional SIB1-PDCCH is also the same as that used by the first SIB1-PDCCH.

In addition, the additional SIB1-PDCCH is checked by using a radio network temporary identifier SI-RNTI of first system information. Alternatively, the additional SIB1-PDCCH is checked by using a second SI-RNTI, where the second SI-RNTI is generated based on a cell identifier.

Optionally, the additional SIB1-PDCCH is a supplementary resource of the first SIB1-PDCCH, and cannot be independently demodulated. The additional SIB1-PDCCH and the first SIB1-PDCCH jointly carry the scheduling information carried by the first SIB1-PDCCH. Rate matching is performed on the first SIB1-PDCCH and the additional SIB1-PDCCH as a whole.

Further, a sending periodicity of the additional SIB1-PDCCH is the same as a sending periodicity of the first SIB1-PDCCH. Alternatively, the PBCH or the first SIB1-PDCCH carries third indication information, where the third indication information indicates a sending periodicity of the additional SIB1-PDCCH. For example, the sending periodicity is 20 ms*k, where k is an integer greater than 1, for example, k=2, 4, 8, 16, 32, or 64; or k is a number greater than 0 and less than 1, for example, k=1/2, 1/4, 1/8, 1/10, 1/20, or 1/40.

Further, the additional SIB1-PDCCH and the first SIB1-PDCCH are in a quasi co-located QCL relationship;

the additional SIB1-PDCCH and an SSB corresponding to the first SIB1-PDCCH are in a QCL relationship; or

the additional SIB1-PDCCH and the specific SSB signal are in a QCL relationship.

With reference to the fourth aspect, in at least one embodiment, the network device includes at least one processor and a transceiver, and optionally further includes a memory. The memory is coupled to the processor or is separated from the processor. The transceiver is configured to receive and send data, and is configured to communicate and interact with another device in a communication system. The memory is configured to store a computer program. The processor is configured to support the network device in performing a corresponding function of the network device in the second aspect and at least one embodiment of the second aspect.

For beneficial effects of the implementations of the network device provided in the fourth aspect of embodiments described herein, refer to beneficial effects of the second aspect and at least one embodiment of the second aspect. Details are not described herein again.

According to a fifth aspect, at least one embodiment provides a chip system. The chip system includes a logic circuit and an input/output interface, the input/output interface is configured to input or output a signal or data, and the logic circuit is configured to perform the first aspect and at least one embodiment of the first aspect.

According to a sixth aspect, at least one embodiment provides a chip system. The chip system includes a logic circuit and an input/output interface, the input/output interface is configured to input or output a signal or data, and the logic circuit is configured to perform the second aspect and at least one embodiment of the second aspect.

According to a seventh aspect, at least one embodiment provides a computer-readable storage medium, where the computer-readable storage medium stores a computer program. In response to the computer program being executed by a processor, some or all steps of the method according to the first aspect, the second aspect, and at least one embodiment of the first aspect and the second aspect are performed.

According to an eighth aspect, at least one embodiment provides a computer program product including executable instructions. In response to the computer program product running on a computer, the method in either of the first aspect and the second aspect and the corresponding possible implementations is performed.

According to a ninth aspect, at least one embodiment further provides a communication apparatus. The apparatus exists in a product form of a chip. A structure of the apparatus includes a processor, and further includes a memory. The memory is configured to be coupled to the processor, and store a program (instructions) and data that are necessary for the apparatus. The processor is configured to execute the computer program stored in the memory, to support the communication apparatus in performing the method in either of the first aspect and the second aspect and the corresponding possible implementations. Optionally, the memory is located in the processor, and is an internal storage. Alternatively, the memory is located outside the processor, is coupled to the processor, and is an external storage.

According to a tenth aspect, at least one embodiment further provides a communication system. The communication system includes a terminal device and a network device. The terminal device is configured to perform the method according to the first aspect and at least one embodiment of the first aspect, and the network device is configured to perform the method according to the second aspect and at least one embodiment of the second aspect.

### BRIEF DESCRIPTION OF DRAWINGS

FIG. 1A is a schematic diagram of a structure of a communication system according to at least one embodiment;

FIG. 1B is a schematic diagram of a structure of another communication system according to at least one embodiment;

FIG. 1C-1 and FIG. 1C-2 are a schematic diagram of a structure of another communication system according to at least one embodiment;

FIG. 2 is a schematic flowchart of a physical downlink control channel transmission method according to at least one embodiment;

FIG. 3A to FIG. 3L are schematic diagrams of time-frequency resource distribution of an additional SIB1-PDCCH and a first SIB1-PDCCH according to at least one embodiment;

FIG. 4 is a schematic diagram of rate matching of an extended SIB1-PDCCH according to at least one embodiment;

FIG. 5A is a schematic diagram of a structure of a communication apparatus according to at least one embodiment;

FIG. 5B is a schematic diagram of a structure of another communication apparatus according to at least one embodiment;

FIG. 6 is a schematic diagram of a structure of a terminal device according to at least one embodiment;

FIG. 7 is a schematic diagram of a structure of a network device according to at least one embodiment; and

FIG. 8 is a schematic diagram of a structure of a chip according to at least one embodiment.

### DESCRIPTION OF EMBODIMENTS

The following describes the technical solutions in embodiments described herein with reference to the accompanying drawings in embodiments described herein.

In the specification, claims, and accompanying drawings of at least one embodiment, the terms “first”, “second”, “third”, “fourth” and so on are intended to distinguish between different objects but do not indicate a particular order. In addition, the terms “including” and “having” and any other variants thereof are intended to cover a non-exclusive inclusion. For example, a process, a method, a system, a product, or a device that includes a series of steps or units is not limited to the listed steps or units, but optionally further includes an unlisted step or unit, or optionally further includes another inherent step or unit of the process, the method, the product, or the device.

An “embodiment” mentioned in this specification means that a particular feature, structure, or characteristic described with reference to this embodiment is included in at least one embodiment. The phrase does not necessarily refer to a same embodiment, and is not an independent or optional embodiment exclusive from another embodiment. A person skilled in the art understands that embodiments described in the specification are combined with another embodiment.

“A plurality of” refers to two or more than two. The term “and/or” describes an association relationship for describing associated objects and represents that three relationships exist. For example, A and/or B represents the following three cases: Only A exists, both A and B exist, and only B exists. The character “/” generally indicates an “or” relationship between the associated objects.

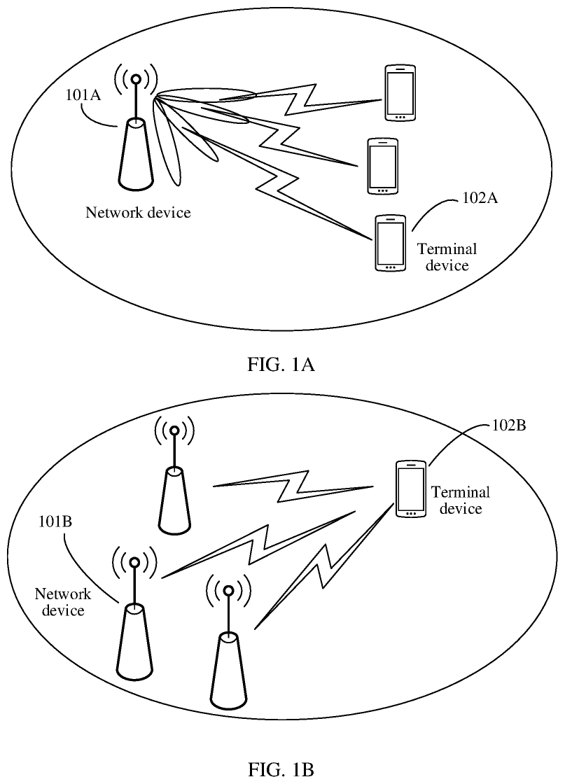

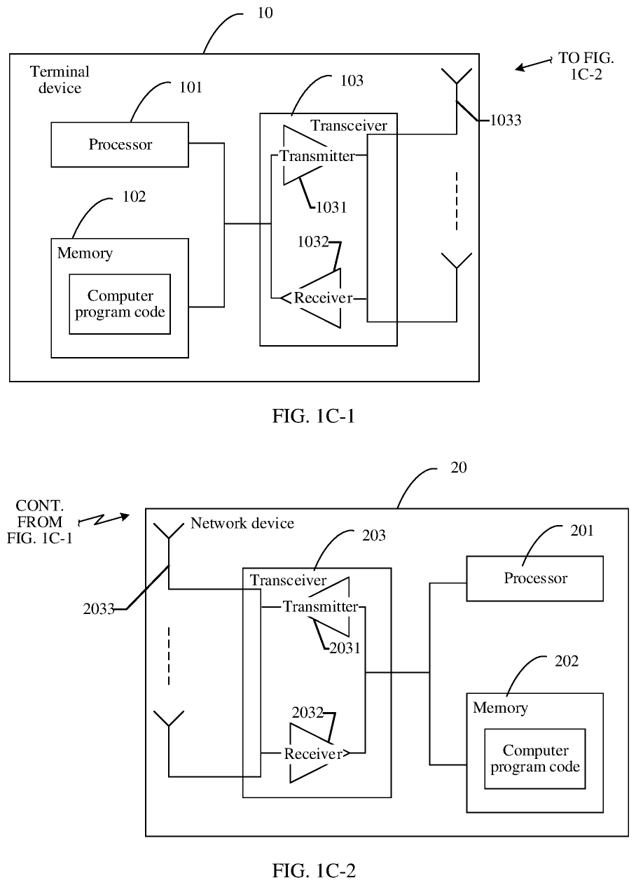

A communication system in at least one embodiment is first described. FIG. 1 is a frame diagram of a communication system according to at least one embodiment. A communication method provided in at least one embodiment is applicable to the communication system shown in FIG. 1, for example, a long term evolution (Long Term Evolution, LTE) system or a 5G NR system, or another future communication system. This is not limited herein. As shown in FIG. 1A and FIG. 1B, for example, the communication system in at least one embodiment includes a network device and a terminal device. A communication system in FIG. 1A includes a single network device and a plurality of terminal devices, and the single network device transmits data or control signaling to a single terminal device or the plurality of terminal devices. A communication system in FIG. 1B includes a plurality of network devices and a single terminal device, and the plurality of network devices simultaneously transmits data or control signaling to the single terminal device. During actual application, the communication system further includes another communication network element, and a quantity of terminal devices and a quantity of network devices are determined based on an actual scenario. FIG. 1A and FIG. 1B are merely examples, and do not constitute a limitation.

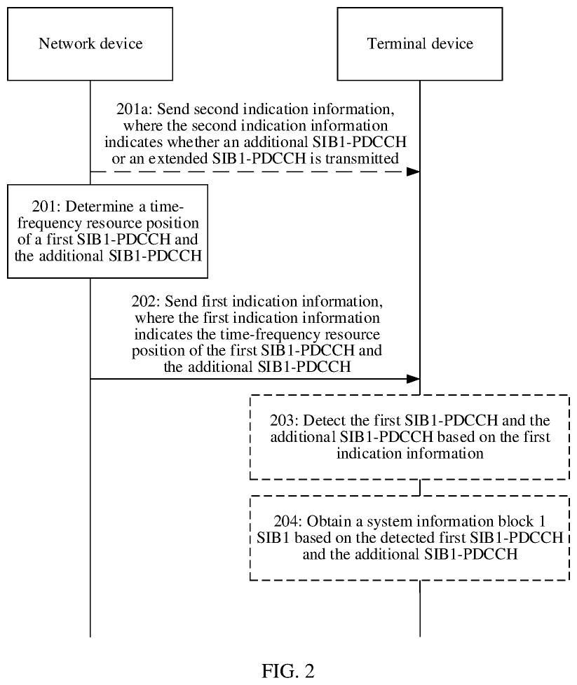

For example, FIG. 1C-1 and FIG. 1C-2 are an implementation of communication between the terminal device and the network device in FIG. 1A or FIG. 1B. A terminal device 10 includes a processor 101, a memory 102, and a transceiver 103. The transceiver 103 includes a transmitter 1031, a receiver 1032, and an antenna 1033. A network device 20 includes a processor 201, a memory 202, and a transceiver 203. The transceiver 203 includes a transmitter 2031 and a receiver 2032. Optionally, the network device 20 further includes an antenna 2033. The antenna 2033 is integrated into the network device 20, or is a remote antenna or a distributed antenna. The receiver 1032 is configured to receive information through the antenna 1033, and the transmitter 1031 is configured to send information to the network device 20 through the antenna 1033. The transmitter 2031 is configured to send information to the terminal device 10 through the antenna 2033. The receiver 2032 is configured to receive, through the antenna 2033, information sent by the terminal device 10.

The network device is a base station or an access point, or is a device that is in an access network and that communicates with a wireless terminal device over an air interface through one or more sectors. The base station is configured to perform conversion between a received over-the-air frame and an IP packet, and serves as a router between the wireless terminal device and the remaining of the access network. The remaining of the access network includes an Internet Protocol (IP) network. The base station coordinates attribute management of the air interface. The base station is an evolved NodeB (evolved NodeB, eNB or eNodeB) in long term evolution (long term evolution, LTE), a relay station or an access point, a base station (gNB) in a 5G network, an integrated access and backhaul (integrated access and backhaul, IAB) node, or the like. This is not limited herein.

The terminal device in at least one embodiment is an entity that is on a user side and that is configured to receive or transmit a signal. The terminal device is a device that provides a user with voice and/or data connectivity, for example, a handheld device having a wireless connection function, or a processing device connected to a wireless modem. The terminal device communicates with a core network via a radio access network (radio access network, RAN), and exchange a voice and/or data with the RAN. The terminal device includes user equipment (user equipment, UE), a wireless terminal device, a mobile terminal device, a device-to-device (device-to-device, D2D) communication terminal device, a vehicle-to-everything (vehicle-to-everything, V2X) terminal device, a machine-to-machine/machine-type communication (machine-to-machine/machine-type communication, M2M/MTC) terminal device, an internet of things (internet of things, IoT) terminal device, a subscriber unit (subscriber unit), a subscriber station (subscriber station), a mobile station (mobile station), a remote station (remote station), an access point (access point, AP), a remote terminal (remote terminal), an access terminal (access terminal), a user terminal (user terminal), a user agent (user agent), a user device (user device), or the like. For example, the terminal device includes a mobile phone (which is also referred to as a “cellular” phone), a computer with a mobile terminal device, or a portable, pocket-sized, handheld, or computer built-in mobile apparatus. For example, the terminal device is a device such as a personal communications service (personal communications service, PCS) phone, a cordless telephone set, a session initiation protocol (session initiation protocol, SIP) phone, a wireless local loop (wireless local loop, WLL) station, or a personal digital assistant (personal digital assistant, PDA). The terminal device alternatively includes a limited device, for example, a device with relatively low power consumption, a device with a limited storage capability, or a device with a limited computing capability. For example, the terminal device includes an information sensing device, for example, a barcode, radio frequency identification (radio frequency identification, RFID), a sensor, a global positioning system (global positioning system, GPS), or a laser scanner.

As an example instead of a limitation, in at least one embodiment, the terminal device alternatively is a wearable device. The wearable device is also referred to as a wearable intelligent device, an intelligent wearable device, or the like, and is a general term of wearable devices that are intelligently designed and developed for daily wear by using a wearable technology, for example, glasses, gloves, watches, clothes, and shoes. The wearable device is a portable device that is directly worn on the body or integrated into clothes or an accessory of a user. The wearable device is not only a hardware device, but also implements a powerful function through software support, data exchange, and cloud interaction. In a broad sense, wearable intelligent devices include full-featured and large-sized devices that implements all or a part of functions without depending on smartphones, for example, smart watches or smart glasses, and include devices that dedicated to only one type of application function and collaboratively works with other devices such as smartphones, for example, various smart bands, smart helmets, or smart jewelry for monitoring physical signs.

In response to the various terminal devices described above being located in a vehicle (for example, placed in the vehicle or installed in the vehicle), the terminal devices is all considered as vehicle-mounted terminal devices. For example, the vehicle-mounted terminal devices are also referred to as on board units (on board units, OBUs).

In NR, a primary synchronization signal (primary synchronization signal, PSS), a secondary synchronization signal (secondary synchronization signal, SSS), and a physical broadcast channel (physical broadcast channel, PBCH) form a synchronization signal/broadcast channel block (SS/PBCH block). The synchronization signal broadcast channel block is sometimes referred to as a synchronization signal block (synchronization signal block, SSB) for short. The SSB is a channel that undertakes a broadcast function, and is for completing an initial access process. A broadcast channel involved in the initial access process further includes a physical downlink control channel (physical downlink control channel, PDCCH) and a physical downlink data channel (physical downlink shared channel, PDSCH) that are for broadcast. The broadcast PDCCH is a control channel that carries scheduling information of broadcast information, and is denoted as a SIB1-PDCCH. The broadcast information mainly refers to system information, for example, a system information block (system information block, SIB). The scheduling information of the broadcast information indicates a resource on which a terminal device receives data information of a SIB1. The PDSCH for broadcast is a data channel that carries the broadcast information, and is denoted as a SIB1-PDSCH. The broadcast channel involved in the initial access process is characterized by carrying the broadcast scheduling information or the broadcast information, and is not a dedicated channel.

An initial access process of a terminal device roughly includes the following steps: (1) performing blind detection on a PSS/SSS, synchronizing cell timing, and obtaining a cell identifier; (2) demodulating a master information block (Master Information Block, MIB) carried on a physical broadcast channel (Physical broadcast Channel, PBCH), where an MIB message includes a system frame number, a subcarrier spacing, and SIB1-PDCCH configuration information (a control resource set indication and a search space indication); and (3) detecting DCI based on a set and search space that are indicated by the SIB1-PDCCH configuration information, where the DCI is scrambled by using an SI-RNTI, and indicates scheduling information of a SIB1 message, such as a frequency domain resource, a time domain resource allocation, a modulation and coding scheme, or a redundancy version; (4) receiving the SIB1 message based on the scheduling information, where the SIB1 includes cell information, specifically including uplink and downlink bandwidth resource information, a cell SSB resource, or the like.

FIG. 1A is used as an example. In an initial access process, a terminal device 102A receives a system information block SIB1 delivered by a network device 101A. The SIB1 includes cell information, specifically including uplink and downlink bandwidth resource information, a cell synchronization signal block SSB resource, or the like. After obtaining the information, the terminal device 102A completes the initial access process. In this process, the terminal device 102A receives the SIB1 at a corresponding position based on scheduling information. The scheduling information of the SIB1 is carried on a SIB1-PDCCH. Therefore, to successfully complete initial access, the terminal device 102A first receives the broadcast SIB1-PDCCH. Currently, a coverage capability design of the SIB1-PDCCH in a 3.5 GHz propagation feature has reached an upper limit. For some new frequency bands, for example, a higher frequency band 6 GHz, a larger path loss is generated, and it is difficult for the SIB1-PDCCH to achieve same coverage. Due to insufficient coverage of the SIB1-PDCCH, the terminal device 102A cannot correctly demodulate the scheduling information carried in the SIB1-PDCCH. As a result, the terminal device 102A cannot obtain the SIB1 message, and further cannot complete the initial access process.

The insufficient coverage of the SIB1-PDCCH herein is understood as an insufficient signal-to-noise ratio. In other words, a signal on the SIB1-PDCCH is weak or the SIB1-PDCCH is greatly affected by noise.

For a problem that a coverage capability of the SIB1-PDCCH on a higher frequency band is insufficient, at least one embodiment provides a SIB1-PDCCH transmission method. In the method, a supplementary SIB1-PDCCH is mainly provided to assist a terminal device in completing an initial access process on the higher frequency band, so that the coverage capability of the SIB1-PDCCH is improved in an initial access phase, and farther cell coverage is further implemented. In addition, forward compatibility of an existing terminal device with the method provided in at least one embodiment is also considered in a specific implementation process.

In at least one embodiment, the supplementary SIB1-PDCCH is used as an extra or additional SIB1-PDCCH transmission resource to improve robustness of an original SIB1-PDCCH. The original SIB1-PDCCH is a SIB1-PDCCH specified in the 3GPP 38.213 protocol, and the supplementary SIB1-PDCCH is an additional SIB1-PDCCH. In the following description, the original SIB1-PDCCH is correspondingly described as a first SIB1-PDCCH, and the supplementary SIB1-PDCCH is correspondingly described as an additional SIB1-PDCCH. This is uniformly described herein, and details are not described again below. In addition, the supplementary SIB1-PDCCH is also named in another manner. This is not limited in at least one embodiment.

A person skilled in the art understands that the additional SIB1-PDCCH is used as a supplement to the first SIB1-PDCCH, and the additional SIB1-PDCCH and the first SIB1-PDCCH are correlated. In response to a terminal device receiving the additional SIB-PDCCH and the first SIB1-PDCCH, correlation superposition is performed. However, noise is independent, and only non-correlation superposition is performed. Therefore, a signal-to-noise ratio of the SIB1-PDCCH is improved by using the additional SIB1-PDCCH, in other words, the coverage capability of the SIB1-PDCCH is improved.

A resource block (resource block, RB) in at least one embodiment is a frequency domain concept. For example, 12 subcarriers are one RB.

In addition, in at least one embodiment, a time-frequency resource position of the first SIB1-PDCCH or a time-frequency resource position of the additional SIB1-PDCCH alternatively is correspondingly understood as a candidate time-frequency resource position of the first SIB1-PDCCH or a candidate time-frequency resource position of the additional SIB1-PDCCH. SIB1-PDCCH detection is correspondingly understood as blind detection specified in an existing protocol.

The following specifically describes, with reference to the accompanying drawings, a physical downlink control channel transmission method provided in at least one embodiment.

In at least one embodiment, a terminal device and a network device are used as an example. At least one embodiment alternatively is applied to a chip on a terminal device side, or is applied to a chip on a network device side.

FIG. 2 is a schematic flowchart of a physical downlink control channel transmission method 200 according to at least one embodiment. The method specifically includes the following steps.

S201: A network device determines a time-frequency resource position of a first SIB1-PDCCH and an additional SIB1-PDCCH.

S202: The network device sends first indication information, where the first indication information indicates the time-frequency resource position of the first SIB1-PDCCH and the additional SIB1-PDCCH.

Correspondingly, a terminal device receives the first indication information sent by the network device. Optionally, the terminal device alternatively obtains the first indication information from another terminal device. For example, in a device-to-device (device-to-device, D2D) scenario, information transmission is implemented by using a sidelink (sidelink, SL). A manner in which the terminal device obtains the first indication information is not limited in at least one embodiment.

The time-frequency resource position of the first SIB1-PDCCH and the additional SIB1-PDCCH includes: a time-frequency resource position of the first SIB1-PDCCH and a time-frequency resource position of the additional SIB1-PDCCH; or an overall time-frequency resource position of the first SIB1-PDCCH and the additional SIB1-PDCCH. The first SIB1-PDCCH and the additional SIB1-PDCCH is considered as an extended SIB1-PDCCH as a whole. In this case, the first SIB1-PDCCH and the additional SIB1-PDCCH is not distinguished, but are considered as a whole. The first SIB1-PDCCH and the additional SIB1-PDCCH are correspondingly described as the extended SIB1-PDCCH as a whole in the following, and are uniformly described herein.

Before detecting the first SIB1-PDCCH and the additional SIB1-PDCCH or the extended SIB1-PDCCH based on the first indication information, the terminal device first determines whether the additional SIB1-PDCCH or the extended SIB1-PDCCH is transmitted, to avoid a case in which power consumption of the terminal device is increased in response to the terminal device blindly detecting the additional SIB1-PDCCH or the extended SIB1-PDCCH in response to the terminal device not determining whether the additional SIB1-PDCCH or the extended SIB1-PDCCH is transmitted. Specifically, at least one embodiment provides the following several implementations of determining whether the additional SIB1-PDCCH or the extended SIB1-PDCCH is transmitted.

In at least one embodiment, in a protocol in some systems or some scenarios, the additional SIB1-PDCCH or the extended SIB1-PDCCH is transmitted by default. For example, according to the protocol, the additional SIB1-PDCCH or the extended SIB1-PDCCH is transmitted by default on some frequencies (for example, some specific frequency bands, such as 6 GHz).

In the foregoing implementation, in the protocol, in some scenarios (for example, farther cell coverage or a larger path loss on a new frequency band), the additional SIB1-PDCCH or the extended SIB1-PDCCH is transmitted by default. For example, the additional SIB1-PDCCH or the extended SIB1-PDCCH being transmitted by default is indicated by using a frequency configuration, so that no additional signaling overhead is generated.

In at least one embodiment, in a specific scenario in which the additional SIB1-PDCCH or the extended SIB1-PDCCH being transmitted by default is not stipulated in a protocol, the terminal device first determines whether the additional SIB1-PDCCH or the extended SIB1-PDCCH is transmitted.

Optionally, before step 201, step 201a is added: The network device sends second indication information, where the second indication information indicates whether the additional SIB1-PDCCH or the extended SIB1-PDCCH is transmitted. Correspondingly, the terminal device directly receives the second indication information from the network device or obtain the second indication information from another terminal device. This is not limited in at least one embodiment.

In at least one embodiment, a PBCH carries the second indication information. For example, the last reserved bit or a spare bit on the PBCH carries the second indication information. For example, whether the additional SIB1-PDCCH or the extended SIB1-PDCCH is transmitted is indicated based on a value 0 or 1 of the last bit. 0 indicates that the additional SIB1-PDCCH or the extended SIB1-PDCCH is not transmitted, and 1 indicates that the additional SIB1-PDCCH or the extended SIB1-PDCCH is transmitted. Alternatively, 0 indicates that the additional SIB1-PDCCH or the extended SIB1-PDCCH is transmitted, and 1 indicates that the additional SIB1-PDCCH or the extended SIB1-PDCCH is not transmitted.

In at least one embodiment, the first SIB1-PDCCH carries the second indication information, and the second indication information specifically indicates whether the additional SIB1-PDCCH corresponding to the first SIB1-PDCCH is transmitted; whether additional SIB1-PDCCHs corresponding to all SSBs are transmitted; or whether the additional SIB1-PDCCH is to be transmitted in a preset time unit. All SSBs is SSBs corresponding to a current periodicity, a specified periodicity, or all periodicities. The preset time unit is time domain information, for example, is a frame, a subframe, a slot, a mini-slot, or a symbol.

In at least one embodiment, the terminal device receives a specific signal sent by the network device, where the specific signal indicates whether the additional SIB1-PDCCH or the extended SIB1-PDCCH is to be transmitted. In response to the terminal device receiving the specific signal, the terminal device considers that the additional SIB1-PDCCH or the extended SIB1-PDCCH is to be transmitted. For example, the specific signal is a specific SSB signal, and the specific SSB signal has one or more of the following features: a primary synchronization signal (Primary Synchronization Signal, PSS) of a specific sequence, a secondary synchronization signal (Secondary Synchronization Signal, SSS) of the specific sequence, a PBCH demodulation reference signal (Demodulation Reference Signal, DMRS) of the specific sequence, a special SSB structure, a special SSB time-frequency position, a synchronization signal SS of a specific frequency offset, or a PBCH of the specific frequency offset.

The PSS of the specific sequence is different from a PSS sequence in an SSB signal corresponding to the first SIB1-PDCCH, the SSS of the specific sequence is different from an SSS sequence in the SSB signal corresponding to the first SIB1-PDCCH, and the specific PBCH DMRS is different from a PBCH DMRS sequence in the SSB signal corresponding to the first SIB1-PDCCH. For example, the foregoing specific sequence is generated in a manner stipulated in a protocol, for example, by using a cyclic shift. The special SSB structure: For example, the SSB disables the PSS and does not send the PSS, and only the SSS and/or the PBCH are sent. The special SSB time-frequency position: For example, the SSB time-frequency position is different from an existing time-frequency position of an SSB corresponding to the first SIB1-PDCCH. The SS/PBCH of the specific frequency offset: For example, an SSB obtained by performing specific frequency offset on the SS and/or the PBCH is not located in a synchronization raster or is not at a synchronization raster position specified in a protocol. The terminal device, in response to the SS/PBCH of the specific frequency offset being detected, the additional SIB1-PDCCH or the extended SIB1-PDCCH is to be transmitted.

In the foregoing implementation, the terminal device determines, by obtaining the second indication information, whether the additional SIB1-PDCCH or the extended SIB1-PDCCH is transmitted. In this indication manner, dynamic indication of the additional SIB1-PDCCH or the extended SIB1-PDCCH is implemented, so that power consumption of the terminal device is reduced, and detection efficiency is improved.

After determining that the additional SIB1-PDCCH or the extended SIB1-PDCCH is transmitted, the terminal device further determines the time-frequency resource position of the first SIB1-PDCCH and the time-frequency resource position of the additional SIB1-PDCCH or the time-frequency resource position of the extended SIB1-PDCCH based on the first indication information. Specifically, the following several implementations is included.

In at least one embodiment, the first indication information includes one or more offsets, and the offset indicates an offset of the time-frequency resource position of the additional SIB1-PDCCH relative to the time-frequency resource position of the first SIB1-PDCCH; or the offset indicates an offset of the time-frequency resource position of the additional SIB1-PDCCH relative to a time-frequency resource position of a synchronization signal block SSB. The terminal device obtains one or more time-frequency resource positions of the additional SIB1-PDCCH based on the one or more offsets.

In the foregoing implementation, the time-frequency resource position of the additional SIB1-PDCCH is related to the time-frequency resource position of the first SIB1-PDCCH. Any one of the one or more offsets includes at least one of a time domain offset value and a frequency domain offset value. To be specific, relative to the time-frequency resource position of the first SIB1-PDCCH, the time-frequency resource position of the additional SIB1-PDCCH has an offset only on a time domain resource, has an offset only on a frequency domain resource, or has an offset on both a time domain resource and a frequency domain resource. Specific offset magnitude is indicated by using an offset.

For example, one or more fixed offsets is directly stipulated in a protocol, and each offset indicates specific offset magnitude. For example but not limited to, an offset in frequency domain is X RBs or X subcarriers, and an offset in time domain is Y symbols (symbols) or Y slots (slots). Optionally, each offset indicates an offset value of the additional SIB1-PDCCH relative to a maximum index or a minimum index corresponding to the first SIB1-PDCCH on a time domain resource and/or a frequency domain resource. For example, a frequency domain offset is an offset value of the additional SIB1-PDCCH relative to a minimum RB index of a frequency domain resource occupied by the first SIB1-PDCCH or an offset value of the additional SIB1-PDCCH relative to a maximum RB index of the frequency domain resource occupied by the first SIB1-PDCCH. A time domain offset is an offset value of the additional SIB1-PDCCH relative to the 1^{st} symbol or the last symbol of a time domain resource occupied by the first SIB1-PDCCH.

The foregoing offset manner is merely an example for description. Specifically, not only the offset values relative to the minimum index and the maximum index, but a plurality of offset manners is specified in the protocol. This is not limited in at least one embodiment.

In at least one embodiment, the one or more offsets are associated with indication information of the time-frequency resource position of the first SIB1-PDCCH. Control resource set (control resource set) configuration information and search space (search space) configuration information indicate the time-frequency resource position of the first SIB1-PDCCH. Further, the one or more offsets is an offset value of the indication information of the time-frequency resource position of the first SIB1-PDCCH. For example, a frequency domain offset included in the offsets is an additional offset of X RBs based on RB offset value information indicated in the control resource set configuration information, and a time domain offset is an additional offset of Y symbols based on the 1^{st} symbol index indicated in the search space configuration information.

In addition, in response to the first indication information including a plurality of offsets, the terminal device assumes that the additional SIB1-PDCCH is transmitted at only one time-frequency resource position in a plurality of time-frequency resource positions that correspond to the plurality of offsets and that are of the additional SIB1-PDCCH. The terminal device obtains one available additional SIB1-PDCCH at the plurality of time-frequency resource positions of the additional SIB1-PDCCH, and the plurality of offsets ensures that there is another optional time-frequency resource position after a time-frequency resource position that corresponds to an offset and that is of the additional SIB1-PDCCH is occupied, to improve coverage of the SIB1-PDCCH.

In at least one embodiment, the network device sends the specific signal, for example, the specific SSB signal. Correspondingly, the terminal device receives the specific signal, where the specific signal carries or indicates time-frequency resource position information of the additional SIB1-PDCCH and the first SIB1-PDCCH. Optionally, a manner of indicating the time domain resource position of the first SIB1-PDCCH and the additional SIB1-PDCCH in the specific signal is the same as an indication manner of the first SIB1-PDCCH in the protocol 38.213, for example, indicating by using an index in the control resource set configuration information and the search space configuration information.

The terminal device determines the time-frequency resource position of the additional SIB1-PDCCH based on the one or more offsets. In response to the time-frequency resource position of the additional SIB1-PDCCH overlapping one of the time-frequency resource position of the first SIB1-PDCCH, the time-frequency resource position of the SSB, a time-frequency resource position of a system information block 1 physical downlink data channel SIB1-PDSCH, and a time-frequency resource position of a system information block 1 SIB1 physical downlink data channel demodulation reference signal SIB1-PDSCH DMRS, the terminal device assumes that the additional SIB1-PDCCH is not transmitted at the time-frequency resource position of the additional SIB1-PDCCH, which alternatively is understood as that the terminal device does not detect the additional SIB1-PDCCH at the time-frequency resource position of the additional SIB1-PDCCH, and the terminal device discards time-frequency resource position information of the additional SIB1-PDCCH. In response to the time-frequency resource position of the additional SIB1-PDCCH conflicting with one of the foregoing resource positions, the terminal device assumes that the additional SIB1-PDCCH is not transmitted. The time-frequency resource position of the additional SIB1-PDCCH alternatively conflicts with a plurality of the foregoing resource positions.

In the foregoing embodiment, the time-frequency position of the additional SIB1-PDCCH is indicated by using the one or more offsets. An implementation is simple, and signaling overheads are low.

In at least one embodiment, the offset is preconfigured on the terminal device. In other words, the offset is directly specified in a protocol, and the terminal device does not obtain the offset from the network device or another device. In other words, the offset is not indicated by the first indication information, and the terminal device determines the time-frequency resource position of the additional SIB1-PDCCH based on the locally stored offset and the time-frequency resource position of the first SIB1-PDCCH.

In at least one embodiment, the first indication information directly carries or explicitly indicates the one or more offsets. The terminal device receives the first indication information sent by the network device, and determines the time-frequency resource position of the additional SIB1-PDCCH based on the offset carried in the first indication information.

In at least one embodiment, the first indication information indirectly carries or implicitly indicates the one or more offsets. For example, sub-configuration information of first configuration information is determined based on the first indication information, where the sub-configuration information includes the one or more offsets. The first configuration information includes a plurality of pieces of sub-configuration information. The first configuration information is predefined or preconfigured, and the terminal device and the network device store the first configuration information.

Specifically, the first configuration information is implemented in two manners.

In at least one embodiment, the first configuration information includes the time-frequency resource position information of the first SIB1-PDCCH and the time-frequency resource position information of the additional SIB1-PDCCH. In other words, the time-frequency resource position information of the first SIB1-PDCCH and the time-frequency resource position information of the additional SIB1-PDCCH are uniformly configured in the first configuration information. The first configuration information includes one or more of the following information: a time-frequency position offset relationship between the additional SIB1-PDCCH and the first SIB1-PDCCH, a difference between scheduling information carried by the additional SIB1-PDCCH and the first SIB1-PDCCH, a time-frequency resource allocation manner of at least one of the first SIB1-PDCCH and the additional SIB1-PDCCH, a code rate of at least one of the first SIB1-PDCCH and the additional SIB1-PDCCH, a search space periodicity of at least one of the first SIB1-PDCCH and the additional SIB1-PDCCH, and a quantity of search space of at least one of the first SIB1-PDCCH and the additional SIB1-PDCCH per slot.

In at least one embodiment, the first configuration information includes time-frequency resource position information of the extended SIB1-PDCCH. Specifically, the first configuration information includes one or more of the following information: scheduling information carried on the extended SIB1-PDCCH, a time-frequency resource allocation manner, a code rate, a search space periodicity, and a quantity of search space per slot. The time-frequency resource position information of the first SIB1-PDCCH is included in other configuration information. The other configuration information herein is configuration information other than the first configuration information, and is also considered as second configuration information. In other words, in this implementation, the first configuration information includes only the time-frequency resource position information of the extended SIB1-PDCCH. In this case, the first SIB1-PDCCH and the additional SIB1-PDCCH are not distinguished, but the first SIB1-PDCCH and the additional SIB1-PDCCH are used as an overall resource (namely, the extended SIB1-PDCCH) to indicate time-frequency position information. The second configuration information includes the time-frequency resource position information of the first SIB1-PDCCH. In response to the terminal device determining the time-frequency resource position information of the SIB1-PDCCH, whether the first configuration information or the second configuration information is specifically used is determined based on a transmission status of the SIB1-PDCCH. For example, in a scenario in which the extended SIB1-PDCCH is transmitted by default (for example, a higher frequency band or farther cell coverage) or the terminal device obtains transmission indication information of the extended SIB1-PDCCH, the terminal device needs to determine specific sub-configuration information in the first configuration information based on the first indication information. In response to the extended SIB1-PDCCH not being transmitted, the terminal device needs to determine specific sub-configuration information in the second configuration information based on the first indication information.

A time-frequency resource distribution pattern of the additional SIB1-PDCCH and the first SIB1-PDCCH is directly stipulated in a protocol, or a set of time-frequency resource mapping rules of the additional SIB1-PDCCH and the first SIB1-PDCCH is defined in a protocol.

For the foregoing descriptions, the following provides an example of a specific distribution pattern of the additional SIB1-PDCCH in time domain and frequency domain. For ease of understanding a distribution condition, the additional SIB1-PDCCH is divided into a part of the additional SIB1-PDCCH and a remaining part of the additional SIB1-PDCCH other than the part of the additional SIB1-PDCCH for description. The distribution condition indicates time-frequency resources occupied by the additional SIB1-PDCCH and the first SIB1-PDCCH, and is not an actual resource mapping process, and does not represent a mapping sequence.

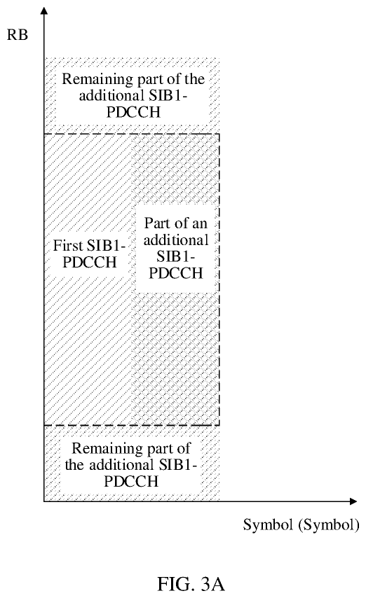

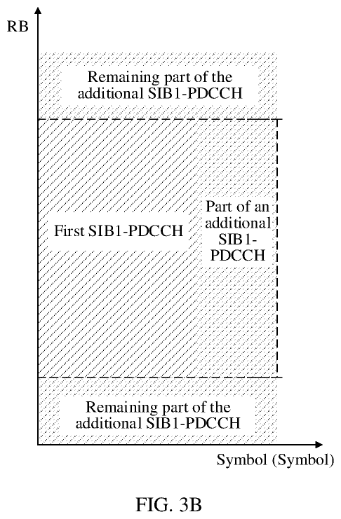

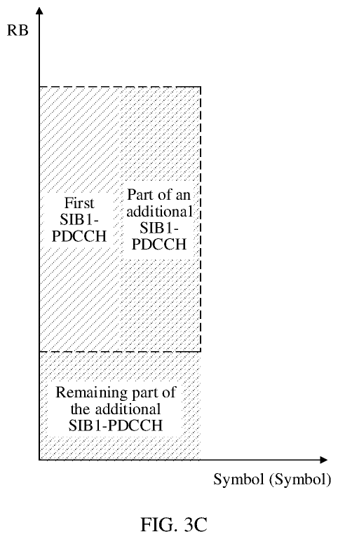

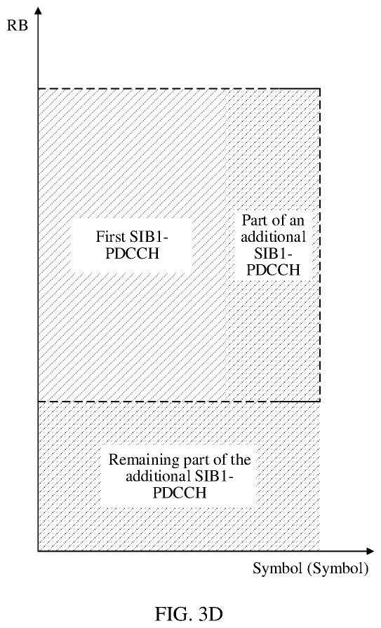

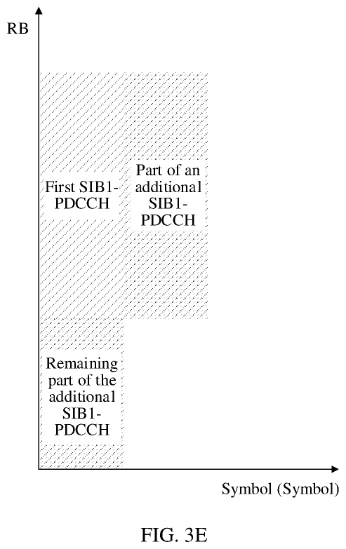

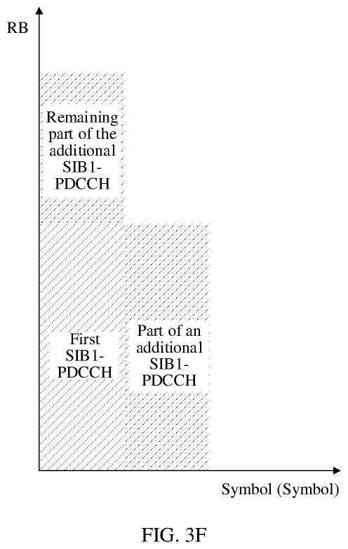

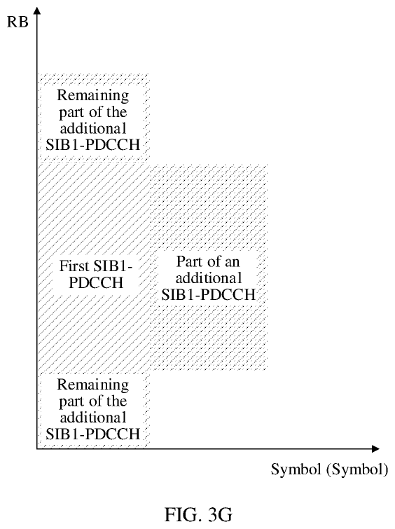

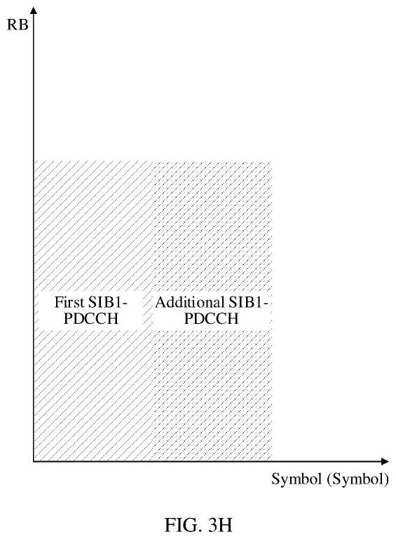

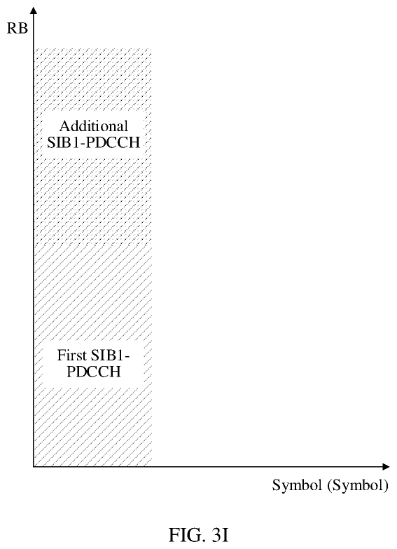

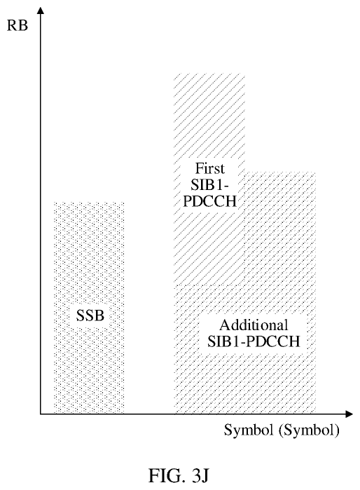

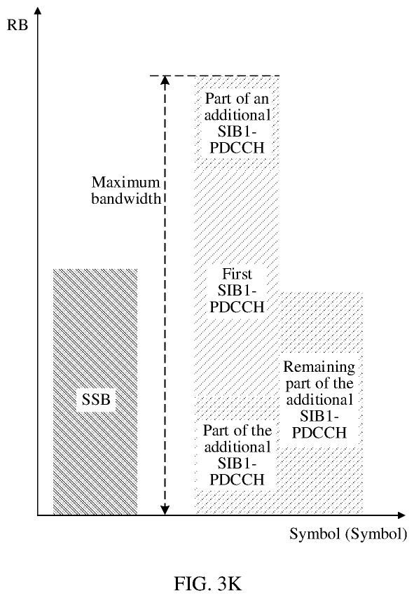

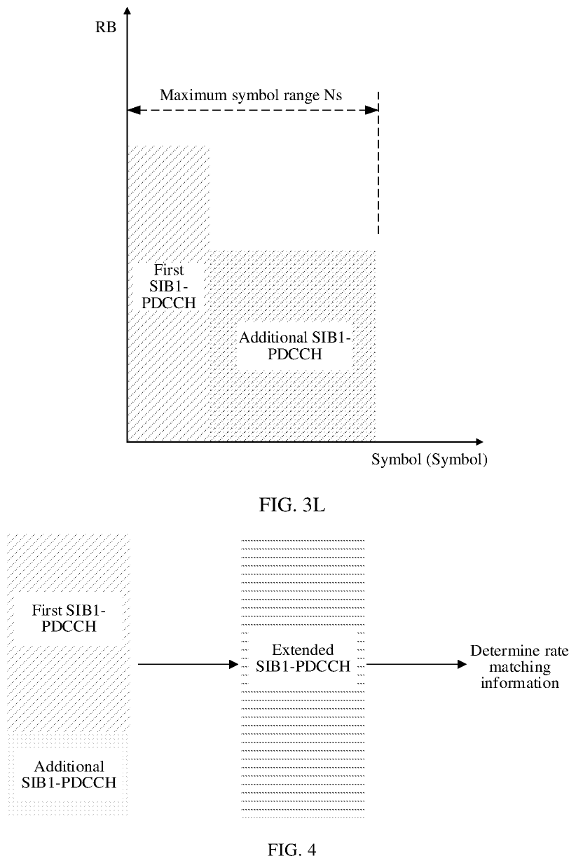

Example 1 of distribution of the first SIB1-PDCCH and the additional SIB1-PDCCH (refer to FIG. 3A to FIG. 3D):

The part of the additional SIB1-PDCCH is distributed on a symbol to which the first SIB1-PDCCH is not mapped in symbols whose time domain index numbers are 0, 1, and 2. In other words, the part of the additional SIB1-PDCCH is distributed on a symbol except a symbol to which the first SIB1-PDCCH is mapped in the symbols whose time domain index numbers are 0, 1, and 2. A range of RBs occupied by the part of the additional SIB1-PDCCH in frequency domain is the same as a range of RBs occupied by the first SIB1-PDCCH. After the part of the additional SIB1-PDCCH is removed from the additional SIB1-PDCCH, the remaining part of the additional SIB1-PDCCH is distributed on two sides or a same side of frequency domain resources jointly occupied by the part of the additional SIB1-PDCCH and the first SIB1-PDCCH, and symbols occupied by the remaining part of the additional SIB1-PDCCH are the sames as symbols jointly occupied by the part of additional SIB1-PDCCH and the first SIB1-PDCCH.

In at least one embodiment, as shown in FIG. 3A and FIG. 3B, quantities of RBs that are distributed on the two sides of the frequency domain resources jointly occupied by the part of the additional SIB1-PDCCH and the first SIB1-PDCCH and that are of the remaining part of the additional SIB1-PDCCH are the same.

In at least one embodiment, for example, as shown in FIG. 3C and FIG. 3D, the remaining part of the additional SIB1-PDCCH is distributed on a side (which is represented by an index value, and is an RB side represented by a low index value) of a frequency domain resource with a lowest frequency in the frequency domain resources jointly occupied by the part of the additional SIB1-PDCCH and the first SIB1-PDCCH. Alternatively, the remaining part of the additional SIB1-PDCCH is distributed on a side (which is an RB side represented by a high index value) of a frequency domain resource with a highest frequency in the frequency domain resources jointly occupied by the part of the additional SIB1-PDCCH and the first SIB1-PDCCH.

In at least one embodiment, X RBs are one frequency domain unit (where for example, six RBs are one frequency domain unit, and six is the same as a quantity of RBs in a control channel unit). The remaining part of the additional SIB1-PDCCH is distributed, in a unit of one frequency domain unit, on the side (which is the RB side represented by the low index value) of the frequency domain resource with the lowest frequency or the side (which is the RB side represented by the high index value) of the frequency domain resource with the highest frequency in the frequency domain resources jointly occupied by the part of the additional SIB1-PDCCH and the first SIB1-PDCCH.

In at least one embodiment, a quantity of RBs included in the additional SIB1-PDCCH is greater than or equal to a quantity of RBs included in the first SIB1-PDCCH. For example, the first SIB1-PDCCH includes 24 RBs, and the additional SIB1-PDCCH includes 48 RBs. X RBs (for example, X=24) thereof and the first SIB1-PDCCH are time division multiplexed, and the remaining 24 RBs and the first SIB1-PDCCH are frequency division multiplexed (for example, as shown in FIG. 3A or FIG. 3C). For another example, the first SIB1-PDCCH includes 48 RBs, and the additional SIB1-PDCCH includes 48 RBs. X RBs (for example, X=24) thereof and the first SIB1-PDCCH are time division multiplexed, and the remaining 24 RBs and the first SIB1-PDCCH are frequency division multiplexed (for example, as shown in 3B or 3D).

Example 2 of distribution of the first SIB1-PDCCH and the additional SIB1-PDCCH (refer to FIG. 3E to FIG. 3G):

The part of the additional SIB1-PDCCH is distributed on a symbol to which the first SIB1-PDCCH is not mapped in symbols whose time domain index numbers are 0, 1, and 2. A start position and an end position of RBs occupied by the part of the additional SIB1-PDCCH are the same as a start position and an end position of RBs occupied by the first SIB1-PDCCH in frequency domain. The remaining part of the additional SIB1-PDCCH other than the part of the additional SIB1-PDCCH in the additional SIB1-PDCCH and the first SIB1-PDCCH is frequency division multiplexed.

In at least one embodiment, for example, as shown in FIG. 3E and FIG. 3F, the remaining part of the additional SIB1-PDCCH is distributed on a side (which is an RB side represented by a low index value) of a frequency domain resource with a lowest frequency in frequency domain resources occupied by the first SIB1-PDCCH or a side (which is an RB side represented by a high index value) of a frequency domain resource with a highest frequency in the frequency domain resources occupied by the first SIB1-PDCCH. Alternatively, as shown in FIG. 3G, the remaining part of the additional SIB1-PDCCH is distributed on two sides of the frequency domain resources occupied by the first SIB1-PDCCH (for example, the remaining part of the additional SIB1-PDCCH is preferentially mapped on a high-index RB side or a low-index RB side, and then mapped on the other side). Quantities of RBs on the two sides is the same or is different.

Example 3 of distribution of the first SIB1-PDCCH and the additional SIB1-PDCCH (refer to FIG. 3H):

The part of the additional SIB1-PDCCH is distributed on a symbol to which the first SIB1-PDCCH is not mapped in symbols whose time domain index numbers are 0, 1, and 2. A quantity of RBs occupied by the additional SIB1-PDCCH and a quantity of RBs occupied by the first SIB1-PDCCH are the same in frequency domain.

Based on the foregoing distribution pattern, optionally, the quantity of RBs occupied by the additional SIB1-PDCCH and the quantity of RBs occupied by the first SIB1-PDCCH are the same in frequency domain, and a start position and an end position of RBs occupied by the additional SIB1-PDCCH are the same as a start position and an end position of RBs occupied by the first SIB1-PDCCH in frequency domain. For example, as shown in FIG. 3H, the first SIB1-PDCCH occupies 24 RBs in frequency domain and occupies the 0^{th} symbol in time domain, and the additional SIB1-PDCCH also occupies 24 RBs in frequency domain and occupies the 1^{st} symbol in time domain.

Example 4 of distribution of the first SIB1-PDCCH and the additional SIB1-PDCCH (refer to FIG. 3I):

The additional SIB1-PDCCH and the first SIB1-PDCCH are frequency division multiplexed, and the additional SIB1-PDCCH and the first SIB1-PDCCH occupy a same symbol in time domain.

For example, as shown in FIG. 3I, the first SIB1-PDCCH occupies 24 RBs in frequency domain and occupies the 0^{th} symbol in time domain, and the additional SIB1-PDCCH also occupies 24 RBs in frequency domain and occupies the 0^{th} symbol in time domain.

Example 5 of distribution of the first SIB1-PDCCH and the additional SIB1-PDCCH (refer to FIG. 3J):

For example, as shown in FIG. 3J, the additional SIB1-PDCCH is distributed on at least one of symbols whose index numbers are 0, 1, and 2 in time domain. A start position of RBs of the additional SIB1-PDCCH distributed in frequency domain is the same as a start position of RBs of an SSB corresponding to the first SIB1-PDCCH or a start position of RBs of the foregoing described specific SSB.

Example 6 of distribution of the first SIB1-PDCCH and the additional SIB1-PDCCH (refer to FIG. 3K):

In a protocol, a maximum bandwidth occupied by the SIB1-PDCCH in frequency domain is N RBs. The additional SIB1-PDCCH uses a start position of RBs of the first SIB1-PDCCH, a start position of RBs of an SSB corresponding to the first SIB1-PDCCH, or a start position of RBs of the specific SSB as a start position of RBs in frequency domain, and the additional SIB1-PDCCH and the first SIB1-PDCCH are frequency division multiplexed in an RB range specified in the protocol.

In at least one embodiment, the maximum bandwidth N RBs is a sum of a quantity of RBs of the first SIB1-PDCCH and a quantity of RBs offset by the first SIB1-PDCCH in frequency domain relative to the SSB corresponding to the first SIB1-PDCCH.

For example, as shown in FIG. 3K, the additional SIB1-PDCCH uses the start position of RBs of the SSB corresponding to the first SIB1-PDCCH as the start position of RBs in frequency domain. In an RB range specified in the protocol, the part of the additional SIB1-PDCCH and the first SIB1-PDCCH are frequency division multiplexed, and the remaining part of the additional SIB1-PDCCH and the first SIB1-PDCCH are time division multiplexed.

Example 7 of distribution of the first SIB1-PDCCH and the additional SIB1-PDCCH (refer to FIG. 3L):

For example, as shown in FIG. 3L, in a protocol, a maximum quantity of symbols occupied by the SIB1-PDCCH in time domain is Ns. The additional SIB1-PDCCH uses a start position of RBs corresponding to the first SIB1-PDCCH, a start position of RBs of an SSB corresponding to the first SIB1-PDCCH, or a start position of RBs of the specific SSB as a start position of RBs in frequency domain, and the additional SIB1-PDCCH and the first SIB1-PDCCH are time division multiplexed in an Ns range specified in the protocol.

In response to the additional SIB1-PDCCH and the first SIB1-PDCCH not being distinguished, the foregoing several distribution patterns is correspondingly understood as time-frequency resource distribution patterns of the extended SIB1-PDCCH.

Specifically, in at least one embodiment, the terminal device assumes that the network device maps resources of the extended SIB1-PDCCH in a manner of first time domain and then frequency domain. For example, in a determined frequency domain range, the resources of the extended SIB1-PDCCH are sequentially mapped, starting from a minimum RB index n corresponding to a minimum symbol index m, to an RB whose index is n corresponding to a symbol whose index is m+1, until time domain symbol mapping is completed, and then the resources of the extended SIB1-PDCCH are mapped from an RB whose index is n+1 corresponding to the minimum symbol index m. In at least one embodiment, the terminal device assumes that the network device maps the resources of the extended SIB1-PDCCH in a manner of first frequency domain and then time domain. For example, in a determined time domain range, the resources of the extended SIB1-PDCCH are sequentially mapped, starting from a minimum RB index n corresponding to a minimum symbol index m, to an RB whose index is n+1 corresponding to a symbol whose index is m, until mapping to corresponding RBs in frequency domain is completed, and then the resources of the extended SIB1-PDCCH are mapped from an RB whose index is n corresponding to a symbol index m+1.

The foregoing distribution patterns are merely examples for description, and there is another distribution pattern in addition to the foregoing examples. This is not limited in at least one embodiment.

The following describes the first configuration information by using an example, where the first configuration information is implemented in a form of a table.

Specifically, in at least one embodiment, the first configuration information includes control resource set configuration information and search space configuration information of the SIB1-PDCCH. The control resource set configuration information is for determining a frequency domain position of the SIB1-PDCCH, and the search space configuration information is for determining a time domain position of the SIB1-PDCCH. Specifically, the control resource set configuration information and the search space configuration information each correspond to one table. Each table includes a plurality of rows of sub-configuration information, and the sub-configuration information in each row is indicated by an index. The index is the first indication information in at least one embodiment. In other words, the first indication information is the index of the sub-configuration information in the first configuration information (the control resource set configuration information and the search space configuration information), and indicates a specific piece of sub-configuration information. For example, the first indication information is carried in a pdcch-ConfigSIB1 field in an MIB message carried on a PBCH. Specifically, a controlResourceSetZero field (4 bits) in the pdcch-ConfigSIB1 field indicates an index in the control resource set configuration information, and a SearchSpaceZero field (4 bits) indicates an index in the search space configuration information.

Similar to a stipulation in the 3GPP protocol 38.213, the control resource set configuration information and the search space configuration information in the first configuration information in at least one embodiment respectively corresponds to a plurality of tables. The terminal device first determines a specific table thereof with reference to a bandwidth of the terminal device and a cell subcarrier spacing, and then determines, based on the first indication information, specific corresponding sub-configuration information in the table. The following describes at least one embodiment with reference to one of the tables. Other tables is configured based on a same inventive concept. For brevity of the specification, the tables are not listed one by one herein.

Example 1: The first configuration information includes the time-frequency resource position of the first SIB1-PDCCH and the time-frequency resource position of the additional SIB1-PDCCH.

The first configuration information includes information shown in Table 1 and Table 2. Table 1 shows the control resource set configuration information, and Table 2 shows the search space configuration information. Information represented by Table 13-4 in the 3GPP protocol 38.213 is used as an example of time-frequency resource information of the first SIB1-PDCCH in Table 1, and information represented by Table 13-11 in the 3GPP protocol 38.213 is used as an example of time-domain information of the first SIB1-PDCCH in Table 2. In Table 1, an SS/PBCH and a CORESET multiplexing pattern are consistent with descriptions in the 3GPP protocol 38.213. A quantity of RBs occupied by a CORESET is a quantity of RBs occupied by the first SIB1-PDCCH, a quantity of symbols occupied by the CORESET is a quantity of symbols occupied by the first SIB1-PDCCH, an offset 1 is an offset of a minimum RB index of the first SIB1-PDCCH to a minimum RB index of a common RB overlapping the 1^{st} RB of a corresponding SS/PBCH block, and an offset 2 (namely, Δf) is an offset of a minimum RB index of the additional SIB1-PDCCH to the minimum RB index of the common RB overlapping the 1^{st} RB of the corresponding SS/PBCH block, or is an offset of the minimum RB index of the additional SIB1-PDCCH to the minimum RB index of the first SIB1-PDCCH, or is an offset of a maximum RB index of the additional SIB1-PDCCH to a maximum RB index of the first SIB1-PDCCH, or is an added RB of the additional SIB1-PDCCH relative to the minimum RB index or the maximum RB index of the first SIB1-PDCCH. This is not specifically limited in at least one embodiment. In Table 2, content of configuration parameters in the first five columns is correspondingly understood as information that is indicated in the protocol 38.213 and that is about the first SIB1-PDCCH. An offset shown in the 6^{th} column is an offset value of the additional SIB1-PDCCH relative to the 1^{st} symbol index or the last symbol index of the first SIB1-PDCCH in time domain, or is an offset value relative to the 1^{st} symbol index or the last symbol index of an SSB. This is not specifically limited in at least one embodiment. Optionally, in Table 2, an offset value, for example, one or two slots, of a CORESET detection periodicity of the additional SIB1 PDCCH relative to a CORESET detection periodicity of the first SIB1-PDCCH is further added.

Specifically, the time-frequency resource distribution pattern of the additional SIB1-PDCCH and the first SIB1-PDCCH shown in FIG. 3H is used as an example. The quantity of RBs included in the additional SIB1-PDCCH is the same as the quantity of RBs of the first SIB1-PDCCH. An example in which the first indication information indicates sub-configuration information corresponding to an index 0 is used for description. In the time-frequency resource distribution pattern of the additional SIB1-PDCCH and the first SIB1-PDCCH shown in FIG. 3H, a value of Δf is 0, and a value of Δs is 1. The foregoing is merely an example for description. Based on a same concept, different values is corresponded in a specific resource distribution pattern. This is not limited in at least one embodiment.

TABLE 1

| | SS/PBCH and | | | | |
|---|---|---|---|---|---|
| | CORESET | Quantity of RBs | Quantity of symbols | | |
| | multiplexing pattern | occupied by a | occupied by the | Offset (Offset) | |
| | (SS/PBCH block and | CORESET | CORESET (Number | (RBs) | |
| Index | CORESET | (Number of RBs | of Symbols | Offset | Offset |
| (Index) | multiplexing pattern) | N_{RB}^{CORESET}) | N_{symbol}^{CORESET}) | 1 | 2 |
| 0 | 1 | 24 | 2 | 0 | Δf |
| 1 | 1 | 24 | 2 | 2 | Δf |
| 2 | 1 | 24 | 2 | 4 | Δf |
| . . . | . . . | . . . | . . . | . . . | . . . |

TABLE 2

| | | Quantity of search space sets per | | Index of the 1^{st} | |
|---|---|---|---|---|---|
| Index | | slot (Number of search space | | symbol | Offset Offset |
| (Index) | O | sets per slot) | M | (First symbol index) | (symbols) |
| 0 | 0 | 1 | 1 | 0 | Δs |

| | | | |
|---|---|---|---|
| 1 | 0½ ½ | {0, in response to i | Δs |
| | | beingeven}, | |
| | | {N_{RB}^{CORESET}, in | |
| | | response to i being | |
| | | odd} | |

| | | | | | |
|---|---|---|---|---|---|
| . . . . . . | . . . | . . . | . . . | . . . | . . . |

Example 2: The first configuration information includes the time-frequency resource position of the extended SIB1-PDCCH.

A quantity of symbols occupied at the time-frequency resource position of the extended SIB1-PDCCH in time domain is greater than a quantity of symbols occupied by the first SIB1-PDCCH in time domain, and a quantity of resource blocks RBs occupied in frequency domain is greater than or equal to a quantity of RBs occupied by the first SIB1-PDCCH in frequency domain. Alternatively, a quantity of RBs occupied at the time-frequency resource position of the extended SIB1-PDCCH in frequency domain is greater than a quantity of RBs occupied by the first SIB1-PDCCH in frequency domain, and a quantity of symbols occupied in time domain is greater than or equal to a quantity of symbols occupied by the first SIB1-PDCCH in time domain.

Further, a time domain resource occupied by the extended SIB1-PDCCH is at least one of symbols whose index numbers are 0 to 2.

Specifically, the first configuration information includes, for example, information shown in Table 3 and Table 4. Table 3 shows control resource set configuration information of the extended SIB1-PDCCH, and Table 4 shows search space configuration information of the extended SIB1-PD′CH. f shown in Table 3 is the quantity of RBs occupied by the extended SIB1-PDCCH in frequency domain, and s′ is the quantity of symbols occupied by the extended SIB1-PDCCH in time domain. A value of s′ is one of 1, 2, and 3. Δf′ is an offset of the extended SIB1-PDCCH to a minimum RB index of a common RB overlapping the 1^{st} RB of a corresponding SS/PBCH block in frequency domain. Table 4 includes information such as search space corresponding to the extended SIB1-PDCCH, a quantity of search space per slot, and a start symbol index. Specific configuration parameter information is the same as configuration parameter information of the first SIB1-PDCCH in the protocol 38.213 (where Table 13-11 in the protocol 38.213 is used as an example), or a set of new search space configuration information is redefined.

For example, a resource distribution pattern of the extended SIB1-PDCCH shown in FIG. 3H is used as an example. In the distribution pattern, the quantity of RBs of the extended SIB1-PDCCH in frequency domain is 24, and the quantity of symbols in time domain is 2. The first indication information indicates an index 0. In this case, a value of f corresponding to the index 0 is 24, and a value of s′ is 2. For a value of Δf′, refer to a frequency domain offset value of the first SIB1-PDCCH in the protocol 38.213. For example, the value of Δf′ is 0. The foregoing is merely an example for description. Based on a same concept, different values is corresponded in a specific resource distribution pattern. This is not limited in at least one embodiment.

TABLE 3

| | | | | |
|---|---|---|---|---|
| ′2 | ′ | f′ | s′ | Δf′ |
| . . . | . . . | . . . | . . . | . . . |

TABLE 4

| | | Quantity of search space | | Index of the |
|---|---|---|---|---|
| | | sets per slot | | 1^{st} symbol |
| Index | | (Number of search space | | (First symbol |
| (Index) | O | sets per slot) | M | index) |
| 0 | 0 | 1 | 1 | 0 |

| | | | |
|---|---|---|---|
| ½ | 2 | 1/2 | {0, in response to i being |
| | | | even}, {N_{RB}^{CORESET}, in |
| | | | response to i being odd} |

| | | | | |
|---|---|---|---|---|
| 2 | 2 | 1 | 1 | 0 |
| . . . | . . . | . . . | . . . | . . . |

In the foregoing examples, the first configuration information is presented in a form of a table. The first configuration information alternatively is implemented by using a formula or in another manner. This is not specifically limited in at least one embodiment.

Optionally, the physical downlink control channel transmission method further includes the following steps.

S203: The terminal device detects the first SIB1-PDCCH and the additional SIB1-PDCCH based on the first indication information.

In at least one embodiment, after the terminal device obtains an indication indicating that the additional SIB1-PDCCH or the extended SIB1-PDCCH is to be transmitted, the terminal device assumes that downlink control information (downlink control information, DCI) corresponding to the additional SIB1-PDCCH or the extended SIB1-PDCCH on different detection opportunities is to be sent. In other words, after sending the additional SIB1-PDCCH or the extended SIB1-PDCCH, the network device determines to send the DCI. In an implementation, after the terminal device receives the indication indicating that the additional SIB1-PDCCH is to be transmitted, the terminal device considers or assumes that DCI corresponding to the first SIB1-PDCCH is to be sent. In other words, the network device sends the additional SIB1-PDCCH, and also determines to send the DCI corresponding to the first SIB1-PDCCH. For example, the foregoing implementation is implemented by using stipulation in a protocol. Further, after obtaining the time-frequency resource position information of the additional SIB1-PDCCH or the extended SIB1-PDCCH, the terminal device detects the additional SIB1-PDCCH or the extended SIB1-PDCCH at the corresponding time-frequency resource position. In at least one embodiment, a detection periodicity of the additional SIB1-PDCCH or the extended SIB1-PDCCH is the same as a detection periodicity of the first SIB1-PDCCH. Alternatively, sending periodicity of the additional SIB1-PDCCH or the extended SIB1-PDCCH is the same as a sending periodicity of the first SIB1-PDCCH.

In at least one embodiment, the detection periodicity of the additional SIB1-PDCCH or the extended SIB1-PDCCH is directly stipulated in a protocol. Alternatively, third indication information is carried on a PBCH or the first SIB1-PDCCH, where the third indication information indicates the detection periodicity of the additional SIB1-PDCCH or the extended SIB1-PDCCH. For example, the detection periodicity of the additional SIB1-PDCCH or the extended SIB1-PDCCH is 20 ms*k, where k is an integer greater than 1 (for example, 2, 4, 8, 16, 32, or 64), or is a number greater than 0 and less than 1 (for example, 1/2, 1/4, 1/8, 1/10, 1/20, or 1/40).

The terminal device detects the additional SIB1-PDCCH or the extended SIB1-PDCCH based on the detection periodicity of the additional SIB1-PDCCH or the extended SIB1-PDCCH.

In addition, in response to the additional SIB1-PDCCH or the extended SIB1-PDCCH being transmitted by default, in at least one embodiment, the terminal device assumes that a function of the additional SIB1-PDCCH or the extended SIB1-PDCCH is enabled. To be specific, the network device transmits the additional SIB1-PDCCH or the extended SIB1-PDCCH, but whether the network device sends the additional SIB1-PDCCH or the extended SIB1-PDCCH at each detection occasion is determined by the network device. In this case, the terminal device detects the additional SIB1-PDCCH or the extended SIB1-PDCCH at different detection occasions. In response to the detection failing, the terminal device considers that the network device does not send the additional SIB1-PDCCH or the extended SIB1-PDCCH. In at least one embodiment, the terminal device assumes that the function of the additional SIB1-PDCCH or the extended SIB1-PDCCH is enabled, and the additional SIB1-PDCCH or the extended SIB1-PDCCH is always transmitted in each detection periodicity. In this case, the terminal device should detect the additional SIB1-PDCCH or the extended SIB1-PDCCH at each detection occasion. In response to the detection failing, the terminal device assumes that the network device sends the additional SIB1-PDCCH or the extended SIB1-PDCCH, but the detection fails. For example, the terminal device jointly demodulates the additional SIB1-PDCCH detected in a current periodicity and the first PDCCH.

S204: The terminal device obtains the system information block 1 SIB1 based on the detected first SIB1-PDCCH and the additional SIB1-PDCCH.

In at least one embodiment, the scheduling information carried on the additional SIB1-PDCCH is independently demodulated. The terminal device considers or assumes that the additional SIB1-PDCCH and the first SIB1-PDCCH carry corresponding scheduling information. For example, the corresponding scheduling information specifically includes but is not limited to the following information: a same SIB1-PDSCH frequency domain resource (Frequency domain resource assignment), a same SIB1-PDSCH time domain resource (Time domain resource assignment), a same SIB1-PDSCH code rate and modulation order (Modulation and coding scheme), and a same SIB1-PDSCH redundancy version (Redundancy version). Optionally, an SIB1-PDSCH redundancy version scheduled by the first SIB1-PDCCH is different from that scheduled by the additional SIB1-PDCCH.

Optionally, the terminal device assumes that a DMRS sequence of the additional SIB1-PDCCH is the same as a DMRS sequence of the first SIB1-PDCCH. On one hand, the terminal device does not need to generate a new DMRS sequence. On the other hand, the same DMRS sequence helps joint detection performed on the additional SIB1-PDCCH and the first SIB1-PDCCH, so that complexity is reduced.

Optionally, the terminal device verifies the first SIB1-PDCCH by using a radio network temporary identifier (System Information-Radio Network Temporary Identifier, SI-RNTI) of the first system information, or the terminal device verifies the additional SIB1-PDCCH by using a second SI-RNTI. The first SI-RNTI is an existing SI-RNTI, and the second SI-RNTI is a newly defined SI-RNTI. The newly defined SI-RNTI is generated based on a cell identifier, and is for only verifying the additional SIB1-PDCCH.

Optionally, the terminal device assumes that the additional SIB1-PDCCH and the first SIB1-PDCCH are for scheduling same PDSCH information. In response to the terminal device successfully demodulating the first SIB1-PDCCH, the terminal device does not detect the additional SIB1-PDCCH. Alternatively, in response to the terminal device successfully demodulating the additional SIB1-PDCCH, the terminal device does not detect the first SIB1-PDCCH.

In response to the terminal device determining that the additional SIB1-PDCCH is to be transmitted, the terminal device assumes a start position, in time domain, of a DMRS of a PDSCH scheduled by using the additional SIB1-PDCCH and the first SIB1-PDCCH is a symbol whose index is 3.

Optionally, the terminal device assumes that the additional SIB1-PDCCH and the first SIB1-PDCCH use same precoding. This helps joint demodulation performed on the additional SIB1-PDCCH and the first SIB1-PDCCH.

In the foregoing embodiment, the additional SIB1-PDCCH and the first SIB1-PDCCH carry the corresponding scheduling information, and the terminal device jointly demodulates the additional SIB1-PDCCH and the first SIB1-PDCCH, to further improve the coverage of the SIB1-PDCCH, and avoid a case in which the terminal device cannot access a network due to insufficient coverage of the SIB1-PDCCH.

In at least one embodiment, the additional SIB1-PDCCH is only used as a supplementary resource of the first SIB1-PDCCH, cannot be independently demodulated, and is for implementing resource expansion for the first SIB1-PDCCH. The first SIB1-PDCCH and the additional SIB1-PDCCH jointly form the extended SIB1-PDCCH. The extended SIB1-PDCCH carries the scheduling information originally carried on the first SIB1-PDCCH. Optionally, a DMRS sequence of the additional SIB1-PDCCH is the same as that of the first SIB1-PDCCH. For example, as shown in FIG. 4, the terminal device performs rate matching based on the extended SIB1-PDCCH. In other words, the terminal device determines a code rate of the extended SIB1-PDCCH based on bit information carried on the extended SIB1-PDCCH, the extended SIB1-PDCCH, and a pilot resource of the extended SIB1-PDCCH.

In the foregoing implementation, the additional SIB1-PDCCH is used as a resource expansion of the first SIB1-PDCCH, and is used together with the first SIB1-PDCCH as a whole resource to carry the scheduling information originally carried by the first SIB1-PDCCH, so that a quantity of used extended resources is more flexible. In a scenario in which the first SIB1-PDCCH is not completely expanded, resource overheads are less, and robustness of the SIB1-PDCCH is improved.

Further, for a system in which the network device performs transmission by using a beam or the terminal device needs to select a beam for receiving, the terminal device assumes that the additional SIB1-PDCCH and the first SIB1-PDCCH have a quasi co-located (Quasi Co-Located, QCL) relationship or there is a quasi co-located relationship between the additional SIB1-PDCCH and the first SIB1-PDCCH, that is, the terminal device receives the additional SIB1-PDCCH by using a receive beam for receiving the first SIB1-PDCCH. Alternatively, the terminal device assumes that the additional SIB1-PDCCH and the SSB corresponding to the first SIB1-PDCCH have a quasi co-located relationship or there is a quasi co-located relationship between the additional SIB1-PDCCH and the SSB corresponding to the first SIB1-PDCCH, that is, the terminal device receives the additional SIB1-PDCCH by using a receive beam for receiving the SSB corresponding to the first SIB1-PDCCH. Alternatively, the terminal device assumes that the additional SIB1-PDCCH and the specific SSB indicating the additional SIB1-PDCCH have a quasi co-located relationship or there is a quasi co-located relationship between the additional SIB1-PDCCH and the specific SSB indicating the additional SIB1-PDCCH, that is, the terminal device receives the additional SIB1-PDCCH by using a receive beam for receiving the specific SSB.

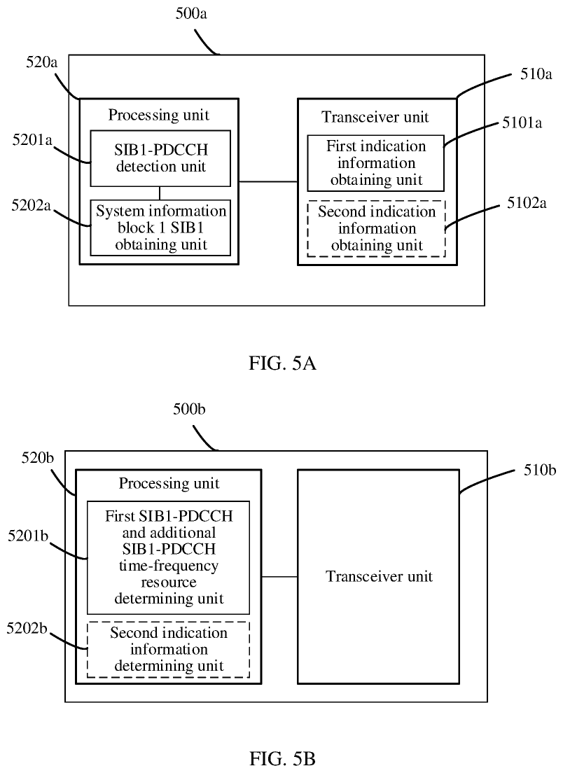

As shown in FIG. 5A, at least one embodiment further provides an apparatus 500a. The apparatus 500a is a terminal device, an apparatus in the terminal device, or an apparatus that is collaboratively used with the terminal device. In at least one embodiment, the apparatus 500a includes modules or units that one-to-one correspond to the methods/operations/steps/actions performed by the terminal device in the foregoing method embodiments. The units is hardware circuits or software, or is implemented by a hardware circuit in combination with software. In at least one embodiment, the apparatus 500a includes a transceiver unit 510a and a processing unit 520a. The transceiver unit 510a communicates with the outside, and the processing unit 520a is configured to process data. The transceiver unit 510a is also referred to as a communication interface or a communication unit.

In response to the apparatus 500a being configured to perform the operations performed by the terminal device, the transceiver unit 510a includes a first indication information obtaining unit 5101a. The first indication information obtaining unit 5101a is configured to obtain first indication information, where the first indication information indicates a time-frequency resource position of a first SIB1-PDCCH and an additional SIB1-PDCCH. Optionally, the transceiver unit 510a further includes a second indication information obtaining unit 5102a. The second indication information obtaining unit 5102a is configured to, for example, obtain second indication information, where the second indication information indicates whether the additional SIB1-PDCCH is transmitted. Further, the processing unit 520a performs processing based on the first indication information or the second indication information obtained by the transceiver unit 510a. For example, the processing unit 520a includes a SIB1-PDCCH detection unit 5201a. The SIB1-PDCCH detection unit 5201a is configured to detect the first SIB1-PDCCH and the additional SIB1-PDCCH based on the first indication information. The processing unit 520a further includes a system information block 1 SIB1 obtaining unit 5202a. The SIB1 obtaining unit 5202a is configured to obtain a system information block 1 SIB1 based on the detected first SIB1-PDCCH and the additional SIB1-PDCCH.

In at least one embodiment, the apparatus 500a is the terminal device in the foregoing method embodiment. In other words, during specific implementation, for function implementation and beneficial effects of each module of the apparatus 500a, refer to descriptions of related method steps in the foregoing method embodiments. For brevity of the specification, details are not described herein again.

In addition, functional unit division in the apparatus 500a is merely an example for description. The processing unit 520a and the transceiver unit 510a further includes other functional units to implement corresponding functions. Alternatively, the processing unit 520a and the transceiver unit 510a implements functions without specific functional unit division. This is not specifically limited in at least one embodiment.

As shown in FIG. 5B, at least one embodiment further provides an apparatus 500b. The apparatus 500b is a network device, an apparatus in the network device, or an apparatus that is collaboratively used with the network device. In at least one embodiment, the apparatus 500b includes modules or units that one-to-one correspond to the methods/operations/steps/actions performed by the network device in the foregoing method embodiments. The units is hardware circuits or software, or is implemented by a hardware circuit in combination with software. In at least one embodiment, the apparatus 500b includes a transceiver unit 510b and a processing unit 520b. The transceiver unit 510b communicates with the outside, and the processing unit 520b is configured to process data. The transceiver unit 510b is also referred to as a communication interface or a communication unit.

In response to the apparatus 500b being configured to perform the operations performed by the network device, the processing unit 520b includes a determining unit 5201b. The determining unit 5201b is, for example, configured to determine a time-frequency resource position of a first SIB1-PDCCH and an additional SIB1-PDCCH. Optionally, the processing unit 520b includes a second indication information determining unit 5202b. The second indication information determining unit 5202b is configured to, for example, determine second indication information, where the second indication information indicates whether the additional SIB1-PDCCH is transmitted. The transceiver unit 510b is configured to perform step 202 shown in FIG. 2 to send first indication information, where the first indication information indicates the time-frequency resource position of the first SIB1-PDCCH and the additional SIB1-PDCCH; or perform step 201a to send the second indication information.

In at least one embodiment, the apparatus 500b is the terminal device in the foregoing method embodiment. In other words, during specific implementation, for function implementation and beneficial effects of each module of the apparatus 500b, refer to descriptions of related method steps in the foregoing method embodiments. For brevity of the specification, details are not described herein again.

In addition, functional unit division in the apparatus 500b is merely an example for description. The processing unit 520b and the transceiver unit 510b further includes other functional units to implement corresponding functions. Alternatively, the processing unit 520b and the transceiver unit 510b implements functions without specific functional unit division. This is not specifically limited in at least one embodiment.

In a network device deployed in a distributed manner, the transceiver unit 510b does not include a radio frequency unit or an antenna.

FIG. 5A and FIG. 5B are merely examples rather than limitations. The terminal device and the network device that include the transceiver unit and the processing unit does not depend on structures shown in FIG. 5A and FIG. 5B. Names of the transceiver unit and the processing unit are merely examples, and are not limited. All units or modules that implements functions of the transceiver unit and the processing unit in the examples is correspondingly understood as the transceiver unit and the processing unit.

In response to the apparatus 500a and the apparatus 500b each being a chip or an integrated circuit system, the chip or the integrated circuit system includes a transceiver unit and a processing unit. The transceiver unit is an input/output circuit or a communication interface. The processing unit is a processor, a microprocessor, or an integrated circuit that is integrated on the chip. Unless otherwise specified, operations such as transmission, sending, and receiving related to the transceiver unit is more generally understood as operations such as output, receiving, and input of the transceiver unit in response to the operations not conflicting with actual functions or internal logic of the operations in related descriptions.

In this embodiment, the apparatus 500a and the apparatus 500b is presented in a form in which the functional units are obtained through division in an integrated manner. The “unit” herein is an ASIC, a circuit, a processor that executes one or more software or firmware programs, a memory, an integrated logic circuit, and/or another component capable of providing the foregoing functions.

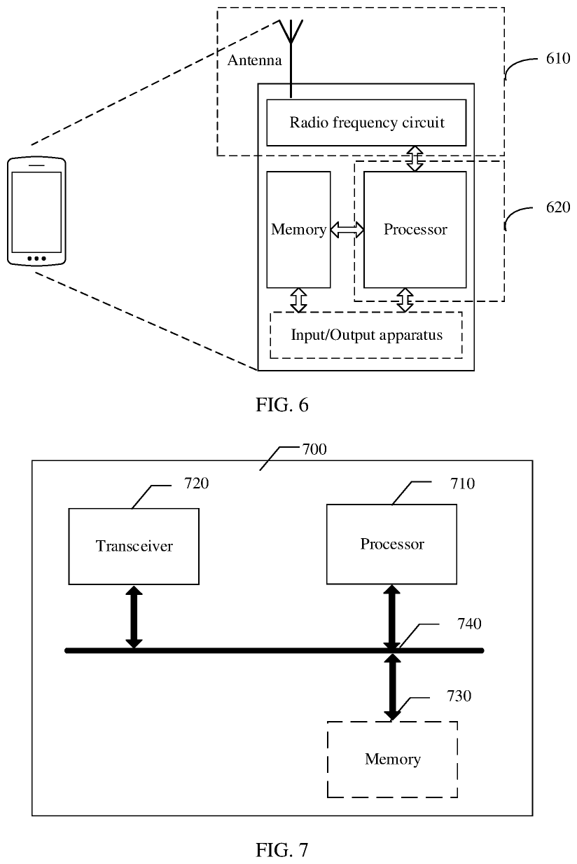

FIG. 6 is a schematic diagram of a structure of a simplified terminal device 600. For ease of understanding and illustration, in FIG. 6, the terminal device is, for example, a mobile phone. As shown in FIG. 6, the terminal device includes a processor, a memory, a radio frequency circuit, an antenna, and an input/output apparatus. The processor is mainly configured to: process a communication protocol and communication data, control the terminal device, execute a software program, process data of the software program, and the like. The memory is mainly configured to store the software program and data. The radio frequency circuit is mainly configured to: perform conversion between a baseband signal and a radio frequency signal, and process the radio frequency signal. The antenna is mainly configured to receive and send a radio frequency signal in a form of an electromagnetic wave. The input/output apparatus, such as a touchscreen, a display, or a keyboard, is mainly configured to: receive data input by a user and output data to the user. Some types of terminal devices have no input/output apparatus.

In response to needing to send data, after performing baseband processing on the to-be-sent data, the processor outputs a baseband signal to the radio frequency circuit; and the radio frequency circuit performs radio frequency processing on the baseband signal and then sends the radio frequency signal to the outside in a form of an electromagnetic wave through the antenna. In response to data being sent to the terminal device, the radio frequency circuit receives the radio frequency signal through the antenna, converts the radio frequency signal into a baseband signal, and outputs the baseband signal to the processor. The processor converts the baseband signal into data, and processes the data. For ease of description, FIG. 6 shows only one memory and one processor. In an actual terminal device product, there is one or more processors and one or more memories. The memory is also referred to as a storage medium, a storage device, or the like. The memory is disposed independent of the processor, or is integrated with the processor. This is not limited in at least one embodiment.

In at least one embodiment, an antenna having sending and receiving functions and the radio frequency circuit is considered as a receiving unit and a sending unit (which is also collectively referred to as a transceiver unit) of the terminal device, and a processor having a processing function is considered as a processing unit of the terminal device. As shown in FIG. 6, the terminal device includes a transceiver unit 610 and a processing unit 620. The transceiver unit 610 alternatively is referred to as a receiver/transmitter (sender), a receiver/transmitter machine, a receiver/transmitter circuit, or the like. The processing unit 620 is also referred to as a processor, a processing board, a processing module, a processing apparatus, or the like. The transceiver unit 610 and the processing unit 620 is configured to perform the actions of the terminal device in the foregoing method embodiments. For example, the transceiver unit 610 is configured to obtain first indication information, where the first indication information indicates a time-frequency resource position of a first SIB1-PDCCH and an additional SIB1-PDCCH; and the processing unit 620 is configured to detect the first SIB1-PDCCH and the additional SIB1-PDCCH based on the first indication information. The processing unit 620 is further configured to obtain a system information block 1 SIB1 based on the detected first SIB1-PDCCH and the additional SIB1-PDCCH.

All related content and beneficial effects of the steps in the foregoing method embodiments is referenced to function descriptions of corresponding functional components, and details are not described herein again.

As shown in FIG. 7, at least one embodiment further provides an apparatus 700. The apparatus 700 is configured to implement the functions of the network device in the foregoing methods. The apparatus is a network device, is an apparatus in the network device, or is an apparatus that is collaboratively used with the network device. The apparatus 700 is a chip system. In at least one embodiment, the chip system includes a chip, or includes a chip and another discrete component. The apparatus 700 includes at least one processor 710, configured to implement the functions of the network device in the methods provided in at least one embodiment. The apparatus 700 further includes a transceiver 720.

The apparatus 700 is specifically configured to perform a related method performed by the network device in the foregoing method embodiments. For example, the transceiver 720 is configured to send first indication information, wherein the first indication information indicates a time-frequency resource position of a first SIB1-PDCCH and an additional SIB1-PDCCH; or is configured to send second indication information, where the second indication information indicates whether the additional SIB1-PDCCH is transmitted. The processor 710 is configured to determine the time-frequency resource position of the first SIB1-PDCCH and the additional SIB1-PDCCH.

In at least one embodiment, for function implementation of each module of the apparatus 700, refer to descriptions of related method steps in the foregoing method embodiments. For brevity of the specification, details are not described herein again.

The apparatus 700 further includes at least one memory 730, configured to store program instructions and/or data. The memory 730 is coupled to the processor 710. The coupling in at least one embodiment is an indirect coupling or a communication connection between apparatuses, units, or modules. The coupling is implemented in electronic, mechanical, and other forms, and is used for information exchange between the apparatuses, the units, or the modules. The processor 710 cooperates with the memory 730. The processor 710 executes the program instructions stored in the memory 730. In at least one embodiment, at least one of the at least one memory is integrated with the processor. In at least one embodiment, the memory 730 is located outside the apparatus 700.

A specific connection medium between the transceiver 720, the processor 710, and the memory 730 is not limited in at least one embodiment. In at least one embodiment, in FIG. 7, the memory 730, the processor 710, and the transceiver 720 are connected through a bus 740, and the bus is represented by a bold line in FIG. 7. A connection manner between other parts is merely an example for description, and does not impose a limitation. The bus is classified into an address bus, a data bus, a control bus, and the like. For ease of representation, only one bold line is used for representation in FIG. 7, but this does not mean that there is only one bus or only one type of bus.

In at least one embodiment, the processor 710 is one or more central processing units (Central Processing Units, CPUs). In response to the processor 710 being one CPU, the CPU is a single-core CPU or a multi-core CPU. The processor 710 is a general-purpose processor, a digital signal processor, an application-specific integrated circuit, a field programmable gate array or another programmable logic device, a discrete gate or transistor logic device, or a discrete hardware component, and implements or execute the methods, steps, and logical block diagrams disclosed in at least one embodiment. The general-purpose processor is a microprocessor or any conventional processor or the like. The steps of the method disclosed with reference to at least one embodiment is directly performed by a hardware processor, or is performed by using a combination of hardware in the processor and a software module.

In at least one embodiment, the memory 730 includes but is not limited to a non-volatile memory such as a hard disk drive (hard disk drive, HDD) or a solid-state drive (solid-state drive, SSD), a random access memory (Random Access Memory, RAM), an erasable programmable read-only memory (Erasable Programmable ROM, EPROM), a read-only memory (Read-Only Memory, ROM), a portable read-only memory (Compact Disc Read-Only Memory, CD-ROM), or the like. The memory is any other medium that can carry or store expected program code in a form of an instruction or a data structure and that is accessed by a computer, but is not limited thereto. The memory 730 in at least one embodiment alternatively is a circuit or any other apparatus that implements a storage function, and is configured to store the program instructions and/or the data.

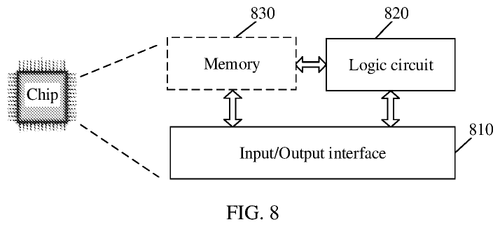

As shown in to FIG. 8, at least one embodiment further provides an apparatus 800, configured to implement the functions of the terminal device and the network device in the foregoing methods. The apparatus 800 is a communication apparatus or a chip in the communication apparatus. The apparatus includes:

at least one input/output interface 810 and a logic circuit 820. The input/output interface 810 is an input/output circuit. The logic circuit 820 is a signal processor, a chip, or another integrated circuit that implements the methods in at least one embodiment.

The apparatus 800 further includes at least one memory 830, configured to store program instructions and/or data. The memory 830 is coupled to the logic circuit 820. The coupling in at least one embodiment is an indirect coupling or a communication connection between apparatuses, units, or modules. The coupling is implemented in electronic, mechanical, and other forms, and is used for information exchange between the apparatuses, the units, or the modules. The logic circuit 820 cooperates with the memory 830. The logic circuit 820 executes the program instructions stored in the memory 830. In at least one embodiment, at least one of the at least one memory is integrated with the logic circuit. In at least one embodiment, the memory 830 is located outside the apparatus 800.

The at least one input/output interface 810 is configured to input or output a signal or data.

For example, in response to the apparatus being a terminal device or is used for a terminal device, in an embodiment, the input/output interface 810 is configured to input first indication information, where the first indication information indicates a time-frequency resource position of a first SIB1-PDCCH and an additional SIB1-PDCCH; and the input/output interface 810 is further configured to input second indication information, where the second indication information indicates whether the additional SIB1-PDCCH or an extended SIB1-PDCCH is transmitted.

For example, in response to the apparatus being a network device, in an embodiment, the input/output interface 810 is configured to output first indication information, where the first indication information indicates a time-frequency resource position of an additional SIB1-PDCCH; and the input/output interface 810 is further configured to output second indication information, where the second indication information indicates whether the additional SIB1-PDCCH or an extended SIB1-PDCCH is transmitted.

The logic circuit 820 is configured to perform a part or all of the steps in any one of the methods provided in at least one embodiment. The logic circuit implements functions implemented by the processing unit 520a in the apparatus 500a, the processing unit 520b in the apparatus 500b, the processor 620 in the apparatus 600, and the processor 710 in the apparatus 700.

In response to the apparatus being a chip used in a terminal device, the chip in the terminal device implements functions of the terminal device in the foregoing method embodiments. The chip in the terminal device receives information from another module (for example, a radio frequency module or an antenna) in the terminal device, where the information is sent by a network device to the terminal device. Alternatively, the chip in the terminal device sends information to another module (for example, a radio frequency module or an antenna) in the terminal device, where the information is sent by the terminal device to a network device.

In response to the apparatus being a chip used in a network device, the chip in the network device implements functions of the network device in the foregoing method embodiments. The chip in the network device receives information from another module (for example, a radio frequency module or an antenna) in the network device, where the information is sent by a terminal device to the network device. Alternatively, the chip in the network device sends information to another module (for example, a radio frequency module or an antenna) in the network device, where the information is sent by the network device to a terminal device.

Based on a same concept as the foregoing method embodiments, at least one embodiment further provides a computer-readable storage medium. The computer-readable storage medium stores a computer program. The computer program is executed by hardware (for example, a processor), to implement a part or all of the steps in any one of the methods performed by any apparatus in at least one embodiment.

Based on a same concept as the foregoing method embodiments, at least one embodiment further provides a computer program product including instructions. In response to the computer program product running on a computer, the computer is enabled to perform a part or all of the steps in any one of the methods in the foregoing aspects.

Based on a same concept as the foregoing method embodiments, at least one embodiment further provides a communication system. The communication system includes the foregoing terminal and/or the foregoing network device. The communication system is configured to implement an operation performed by the terminal device or the network device in any one of the foregoing method embodiments and at least one embodiment of the method embodiments. For example, the communication system has a structure shown in FIG. 1A or FIG. 1B.

Apart or all of the foregoing embodiments is implemented by using software, hardware, firmware, or any combination thereof. In response to software being used to implement the embodiments, all or a part of the embodiments is implemented in a form of a computer program product. The computer program product includes one or more computer instructions. In response to the computer program instructions being loaded and executed on a computer, all or a part of the procedures or functions according to at least one embodiment are generated. The computer is a general-purpose computer, a dedicated computer, a computer network, or other programmable apparatuses. The computer instructions is stored in a computer-readable storage medium or is transmitted from a computer-readable storage medium to another computer-readable storage medium. For example, the computer instructions is transmitted from a website, computer, server, or data center to another website, computer, server, or data center in a wired (for example, a coaxial cable, an optical fiber, or a digital subscriber line) or wireless (for example, infrared, radio, or microwave) manner. The computer-readable storage medium is any usable medium accessible by the computer, or a data storage device, for example, a server or a data center, integrating one or more usable media. The usable medium is a magnetic medium (for example, a floppy disk, a hard disk, or a magnetic tape), an optical medium (for example, an optical disc), a semiconductor medium (for example, a solid-state drive), or the like. In the foregoing embodiments, the description of each embodiment has respective focuses. For a part that is not described in detail in an embodiment, refer to related descriptions in other embodiments.

In the foregoing embodiments, the description of each embodiment has respective focuses. For a part that is not described in detail in an embodiment, refer to related descriptions in other embodiments.

In at least one embodiment, the disclosed apparatuses is implemented in other manners. For example, the described apparatus embodiment is merely an example. For example, division into the units is merely logical function division and is other division in actual implementation. For example, a plurality of units or components is combined or integrated into another system, or some features is ignored or not performed. In addition, the displayed or discussed mutual indirect couplings or direct couplings or communication connections is implemented by using some interfaces. The indirect couplings or communication connections between the apparatuses or units is implemented in electronic or other forms.

The units described as separate parts may or may not be physically separate, and parts displayed as units may or may not be physical units, is located in one location, or is distributed on a plurality of network units. Some or all of the units is selected according to actual needs to achieve the objectives of the solutions of embodiments.

In response to the integrated unit being implemented in the form of the software functional unit and sold or used as an independent product, the integrated unit is stored in a computer-readable storage medium. Based on such an understanding, the technical solutions of at least one embodiment essentially, or the part contributing to the conventional technologies, or all or a part of the technical solutions is implemented in a form of a software product. The computer software product is stored in a storage medium and includes several instructions for instructing a computer device (which is a personal computer, a server, a network device, or the like) to perform all or a part of the steps of the methods described in at least one embodiment.

The foregoing description is merely some specific implementations of at least one embodiment, but is not intended to limit the protection scope of embodiments described herein. Any person skilled in the art is able to make changes and modifications to these embodiments within the technical scope disclosed in at least one embodiment. Therefore, the following claims are intended to be construed as to cover the foregoing embodiments and to indicate changes and modifications falling within the scope of at least one embodiment. Therefore, the protection scope of at least one embodiment shall be subject to the protection scope of the claims.

1. A physical downlink control channel transmission method, wherein the method comprises:
obtaining first indication information, wherein the first indication information indicates a time-frequency resource position of a first system information block 1 physical downlink control channel (SIB1-PDCCH) and an additional SIB1-PDCCH; and
determining the time-frequency resource position of the first SIB1-PDCCH and the additional SIB1-PDCCH based on the first indication information.

2. The method according to claim 1, wherein the method further comprises:
detecting the first SIB1-PDCCH and the additional SIB1-PDCCH based on the first indication information; and
obtaining a system information block 1 (SIB1) based on the detected first SIB1-PDCCH and the additional SIB1-PDCCH.

3. The method according to claim 1, wherein the determining the time-frequency resource position of the first SIB1-PDCCH and the additional SIB1-PDCCH includes: determining the time-frequency resource position of the first SIB1-PDCCH and the time-frequency resource position of the additional SIB1-PDCCH; or determining an overall time-frequency resource position of the first SIB1-PDCCH and the additional SIB1-PDCCH.

4. The method according to claim 1, wherein the obtaining the first indication information includes obtaining one or more offsets, wherein the offset indicates an offset of the time-frequency resource position of the additional SIB1-PDCCH relative to the time-frequency resource position of the first SIB1-PDCCH; or the offset indicates an offset of the time-frequency resource position of the additional SIB1-PDCCH relative to a time-frequency resource position of a synchronization signal block (SSB); and the method further comprises:
obtaining one or more time-frequency resource positions of the additional SIB1-PDCCH based on the one or more offsets.

5. The method according to claim 1, wherein the determining the time-frequency resource position of the first SIB1-PDCCH and the additional SIB1-PDCCH includes determining an overall time-frequency resource position of the first SIB1-PDCCH and the additional SIB1-PDCCH, determining a quantity of symbols occupied in a time domain at the overall time-frequency resource position of the first SIB1-PDCCH and the additional SIB1-PDCCH is greater than a quantity of symbols occupied by the first SIB1-PDCCH in the time domain, and determining a quantity of resource blocks (RBs) occupied in a frequency domain is greater than or equal to a quantity of RBs occupied by the first SIB1-PDCCH in the frequency domain; or
determining a quantity of RBs occupied in the frequency domain at the overall time-frequency resource position of the first SIB1-PDCCH and the additional SIB1-PDCCH is greater than a quantity of RBs occupied by the first SIB1-PDCCH in the frequency domain, and a quantity of symbols occupied in the time domain is greater than or equal to a quantity of symbols occupied by the first SIB1-PDCCH in the time domain.

6. The method according to claim 1, wherein the method further comprises: receiving a specific SSB signal, and the specific SSB signal carries the first indication information,
wherein the specific SSB signal includes at least one of the following information: a primary synchronization signal of a specific sequence, a secondary synchronization signal of a specific sequence, a physical broadcast channel (PBCH) demodulation reference signal of a specific sequence, a special SSB structure, a special SSB time-frequency position, a synchronization signal SS of a specific frequency offset, or a PBCH of a specific frequency offset.

7. The method according to claim 1, wherein the method further comprises:
obtaining second indication information, and the second indication information indicates whether the additional SIB1-PDCCH is transmitted.

8. The method according to claim 1, further comprises determining the additional SIB1-PDCCH and the first SIB1-PDCCH carry corresponding scheduling information, and the corresponding scheduling information includes one or more of the following information: a frequency domain resource of a physical downlink shared channel PDSCH, a time domain resource of the PDSCH, a code rate of the PDSCH, a modulation order of the PDSCH, and a redundancy version of the PDSCH.

9. The method according to claim 1, further comprising:
determining the additional SIB1-PDCCH and the first SIB1-PDCCH are in a quasi co-located (QCL) relationship;
determining the additional SIB1-PDCCH and an SSB corresponding to the first SIB1-PDCCH are in a QCL relationship; or
determining the additional SIB1-PDCCH and the specific SSB signal are in a QCL relationship.

10. A communications apparatus, comprising:
at least one memory storing instructions; and
at least one processor connected to the memory, wherein the at least one processor is configured to execute the instructions to perform operations for:
obtaining first indication information, wherein the first indication information indicates a time-frequency resource position of a first system information block 1 physical downlink control channel (SIB1-PDCCH) and an additional SIB1-PDCCH; and
determining the time-frequency resource position of the first SIB1-PDCCH and the additional SIB1-PDCCH based on the first indication information.

11. The apparatus according to claim 10, wherein the at least one processor is further configured to:
detect the first SIB1-PDCCH and the additional SIB1-PDCCH based on the first indication information; and
obtain a system information block 1 (SIB1) based on the detected first SIB1-PDCCH and the additional SIB1-PDCCH.

12. The apparatus according to claim 10, wherein the time-frequency resource position of the first SIB1-PDCCH and the additional SIB1-PDCCH include: a time-frequency resource position of the first SIB1-PDCCH and a time-frequency resource position of the additional SIB1-PDCCH; or an overall time-frequency resource position of the first SIB1-PDCCH and the additional SIB1-PDCCH.

13. The apparatus according to claim 10, wherein the first indication information includes one or more offsets, and the offset indicates an offset of the time-frequency resource position of the additional SIB1-PDCCH relative to the time-frequency resource position of the first SIB1-PDCCH; or the offset indicates an offset of the time-frequency resource position of the additional SIB1-PDCCH relative to a time-frequency resource position of a synchronization signal block (SSB); and
wherein the at least one processor is further configured to:
obtain one or more time-frequency resource positions of the additional SIB1-PDCCH based on the one or more offsets.

14. The apparatus according to claim 10, wherein a quantity of symbols occupied in time domain at the overall time-frequency resource position of the first SIB1-PDCCH and the additional SIB1-PDCCH is greater than a quantity of symbols occupied by the first SIB1-PDCCH in time domain, and a quantity of resource blocks (RBs) occupied in frequency domain is greater than or equal to a quantity of RBs occupied by the first SIB1-PDCCH in frequency domain; or
a quantity of RBs occupied in frequency domain at the overall time-frequency resource position of the first SIB1-PDCCH and the additional SIB1-PDCCH is greater than a quantity of RBs occupied by the first SIB1-PDCCH in frequency domain, and a quantity of symbols occupied in time domain is greater than or equal to a quantity of symbols occupied by the first SIB1-PDCCH in time domain.

15. The apparatus according to claim 10, wherein the at least one processor is further configured to: receive a specific SSB signal, and the specific SSB signal carries the first indication information,
wherein the specific SSB signal includes at least one of the following information: a primary synchronization signal of a specific sequence, a secondary synchronization signal of a specific sequence, a physical broadcast channel (PBCH) demodulation reference signal of a specific sequence, a special SSB structure, a special SSB time-frequency position, a synchronization signal SS of a specific frequency offset, or a PBCH of a specific frequency offset.

16. The apparatus according to claim 10, wherein the at least one processor is further configured to:
obtain second indication information, and the second indication information indicates whether the additional SIB1-PDCCH is transmitted.

17. The apparatus according to claim 10, wherein the additional SIB1-PDCCH and the first SIB1-PDCCH carry corresponding scheduling information, and
the corresponding scheduling information includes one or more of the following information: a frequency domain resource of a physical downlink shared channel PDSCH, a time domain resource of the PDSCH, a code rate of the PDSCH, a modulation order of the PDSCH, and a redundancy version of the PDSCH.

18. The apparatus according to claim 1, wherein:
the additional SIB1-PDCCH and the first SIB1-PDCCH are in a quasi co-located (QCL) relationship;
the additional SIB1-PDCCH and an SSB corresponding to the first SIB1-PDCCH are in a QCL relationship; or
the additional SIB1-PDCCH and the specific SSB signal are in a QCL relationship.

19. A communications apparatus, comprising:
at least one memory storing instructions; and
at least one processor connected to the memory, wherein the at least one processor is configured to execute the instructions to perform operations for:
determining a time-frequency resource position of a first system information block 1 physical downlink control channel, SIB1-PDCCH, and an additional SIB1-PDCCH; and
sending first indication information, wherein the first indication information indicates the time-frequency resource position of the first SIB1-PDCCH and the additional SIB1-PDCCH.

20. The apparatus according to claim 19, wherein the at least one processor is further configured to:
send a specific synchronization signal block, SSB, and the specific SSB signal carries the first indication information,
wherein the specific SSB signal includes at least one of the following information: a primary synchronization signal of a specific sequence, a secondary synchronization signal of a specific sequence, a PBCH demodulation reference signal of a specific sequence, a special SSB structure, a special SSB time-frequency position, a synchronization signal, SS, of a specific frequency offset, or a physical broadcast channel, PBCH, of a specific frequency offset.
